(19) United States
(12) Patent Application Publication
(10) Pub. No.: US 2017/0359198 A1
(43) Pub. Date: Dec. 14, 2017

(54) NON-TRANSITORY COMPUTER-READABLE STORAGE MEDIUM, COMMUNICATION CONTROL METHOD, AND COMMUNICATION CONTROL DEVICE

(71) Applicant: FUJITSU LIMITED, Kawasaki-shi (JP)

(72) Inventor: Masahiro SATO, Yokohama (JP)

(73) Assignee: FUJITSU LIMITED, Kawasaki-shi, (JP)

(21) Appl. No.: 15/603,826

(22) Filed: May 24, 2017

(30) Foreign Application Priority Data
Jun. 13, 2016 (JP) 2016-117307

(51) Int. Cl. H04L 12/46; H04L 12/66; H04L 12/713; H04L 29/12

(52) U.S. Cl. CPC H04L 12/4633; H04L 61/2007; H04L 12/66; H04L 45/586

(57) ABSTRACT

A communication control method executed by a computer including generating, for each of a plurality of tenants, a plurality of virtual interfaces on a first virtual machine, the first virtual machine executing an application for the plurality of tenants, applying, to the first virtual machine, a first conversion rule in which an IP address of a transmission source of a packet output from the application is converted to one of a plurality of virtual IP addresses allocated for a virtual interface corresponding to one of the plurality of tenants, generating a plurality of gateways on a second virtual machine, applying, to the first virtual machine, routing information so as transmit the packet addressed to the transmission destination to the second virtual machine, and applying, to the second virtual machine, a distribution rule in which the packet is distributed to one of the plurality of gateways.

### CROSS-REFERENCE TO RELATED APPLICATION

This application is based upon and claims the benefit of priority of the prior Japanese Patent Application No. 2016-117307, flied on Jun. 13, 2016, the entire contents of which are incorporated herein by reference.

### FIELD

The embodiments discussed herein are related to a non-transitory computer-readable storage medium, a communication control method, and a communication control device.

### BACKGROUND

In Platform as a Service (PaaS), there is an increased desire for hybrid cloud type PaaS in which a PaaS environment in the cloud and an on-pre environment are connected to one another via a network to provide a service. An on-pre environment herein is an information processing environment that a company or the like has and is also called on-premises environment. Considering security risks, a company does not store, for example, important data in a cloud but holds it in an on-pre environment.

FIG. 36 is a diagram illustrating a connection configuration of a PaaS environment and an on-pre environment. As illustrated in FIG. 36, a PaaS environment 9a in the cloud includes a virtual machine (VM) 93 in which an app 931 operates, and an on-pre environment 9b includes a server 7. In this case, the app 931 is an application and the VM 93 is a virtual information processing device that is constructed on a physical machine included in the cloud.

The VM 93 communicates with the server 7 via the Internet 5 in order to access a database (DB) 71 included in the server 7. A communication between the VM 93 and the server 7 goes via the Internet 5, and therefore, security is enhanced by tunneling and encryption. Tunneling herein is establishing a closed virtual direct line through which two points on a network are joined. A virtual direct line is called tunnel.

In tunneling, a gateway (GW) that performs tunneling processing is used. In FIG. 36, the PaaS environment 9a includes a GW 932 as a gateway, and the on-pre environment 9b includes an on-pre GW 96 as a gateway. The GW 932 is constructed in a VM 93 different from the VM 93 in which the app 931 operates.

Note that there is a technology in which, in a multitenant system, a switch connected to a device that is not capable of recognizing tenant identification information rewrites a header of a packet that is transmitted and received between the device and a server on which a virtual machine with tenant identification information operates, and thereby, the device that is not capable of recognizing tenant identification information is made available for use.

There is another technology in which an identifier of an interface used for connecting a router connected to an intranet for customers and a VM to one another is managed in association with the intranet for customers and the VM, and thereby, even with IPv4, a communication is safely performed between a single VM and a plurality of customer networks.

Furthermore, there is still another technology in which a TCP connection is established between an external terminal device and a NAT-GW device and between a NAT-GW device and a tunneling communication end terminal device and IP addresses and port numbers of the external terminal device and an internal terminal device are managed in association with each TCP connection. In this technology, a packet communication between an external device and an internal device is performed using the TCP connection that corresponds to destination information included in a tunneling packet, and thereby, a tunneling communication is realized between terminal devices in different network systems that are connected to one another via the NAT-GW device.

International Publication Pamphlet No. 2013/172391, Japanese Laid-open Patent Publication No. 2014-93550, and Japanese Laid-open Patent Publication No. 2008-211480 discuss the related art.

### SUMMARY

According to an aspect of the invention, a non-transitory computer-readable storage medium storing a communication control program that causes a computer to execute a process, the process including generating, for each of a plurality of tenants, a plurality of virtual interfaces on a first virtual machine, the first virtual machine executing an application for the plurality of tenants, allocating each of a plurality of virtual IP addresses to each of the plurality of virtual interfaces, applying, to the first virtual machine, a first conversion rule in which an IP address of a transmission source of a packet output from the application is converted to one of the plurality of virtual IP addresses allocated for a virtual interface corresponding to one of the plurality of tenants, the packet relating to the one of the plurality of tenants, generating, for each of a plurality of tenants, a plurality of gateways on a second virtual machine, each of the plurality of gateways being configured to transmit the packet to a transmission destination by tunneling, applying, to the first virtual machine, routing information so as transmit the packet addressed to the transmission destination to the second virtual machine, and applying, to the second virtual machine, a distribution rule in which a packet, transmitted to the second virtual machine based on the routing information, is distributed to one of the plurality of gateways, based on the IP address of the transmission source of the packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a hybrid cloud type PaaS system according to an embodiment;

FIG. 2 is a diagram illustrating a tunneling connection of a hybrid cloud type PaaS system;

FIG. 3 is a diagram illustrating a VRRP;

FIG. 4 is a diagram illustrating a redundant configuration of a gateway;

FIG. 5 is a diagram illustrating a connection between an app and a GW;

FIG. 6 is a diagram illustrating a connection between a GW and the Internet;

FIG. 7 is a diagram illustrating a tunneling connection between a GW and an on-pre GW;

FIG. 8 is a diagram illustrating a flow (an app→a DB) of packet address translation;

FIG. 9A is a first diagram illustrating processing (an app→a DB) that is performed on a packet;

FIG. 9B is a second diagram illustrating processing (an app→a DB) that is performed on a packet;

FIG. 10 is a diagram illustrating a flow (a DB→an app) of packet address translation;

FIG. 11A is a first diagram illustrating processing (a DB→an app) that is performed on a packet;

FIG. 11B is a second diagram illustrating processing (a DB→an app) that is performed on a packet;

FIG. 12 is a diagram illustrating a functional configuration of a GW configuration management device;

FIG. 13 is a table illustrating an example of a redundancy management table;

FIG. 14 is a table illustrating an example of a network management table;

FIG. 15 is a table illustrating an example of a deployment VM management table;

FIG. 16 is a table illustrating an example of a distribution rule management table;

FIG. 17 is a table illustrating an example of an IP address list table;

FIG. 18 is a flowchart illustrating a flow of processing that is performed on a GW generation request and a redundant configuration generation request;

FIG. 19 is a flowchart illustrating a flow of processing that is performed on an app deployment request;

FIG. 20 is a diagram illustrating an initial configuration;

FIG. 21 is a diagram illustrating a table configuration (an initial state) in a GW configuration management device;

FIG. 22 is a diagram illustrating an example of a VRRP for GW VM;

FIG. 23 is a diagram illustrating a table configuration (after VRRP setting for VM) in a GW configuration management device;

FIG. 24 is a diagram illustrating an example of GW generation;

FIG. 25A is a first diagram illustrating a table configuration (after GW generation) in a GW configuration management device;

FIG. 25B is a second diagram illustrating a table configuration (after GW generation) in a GW configuration management device;

FIG. 26 is a diagram illustrating an example of app deployment;

FIG. 27 is a diagram illustrating a table configuration (after app deployment) in a GW configuration management device;

FIG. 28 is a diagram illustrating an example of GW addition;

FIG. 29A is a first diagram illustrating a table configuration (after GW addition) in a GW configuration management device;

FIG. 29B is a second diagram illustrating a table configuration (after GW addition) in a GW configuration management device;

FIG. 30 is a diagram illustrating an example of app addition;

FIG. 31 is a diagram illustrating a table configuration (after app addition) in a GW configuration management device;

FIG. 32 is a diagram illustrating an example of deployment of a plurality of apps of the same tenant;

FIG. 33 is a diagram illustrating a table configuration (after app deployment) in a GW configuration management device;

FIG. 34 is a diagram illustrating an example of tunnel setting;

FIG. 35 is a diagram illustrating a hardware configuration of a computer that executes a GW configuration management program according to an embodiment;

FIG. 36 is a diagram illustrating a connection configuration of a PaaS environment and an on-pre environment;

FIG. 37 is a diagram illustrating a reason why description of an app is changed; and

FIG. 38 is a diagram illustrating a case where a VM that serves as a gateway is constructed for each tenant.

### DESCRIPTION OF EMBODIMENTS

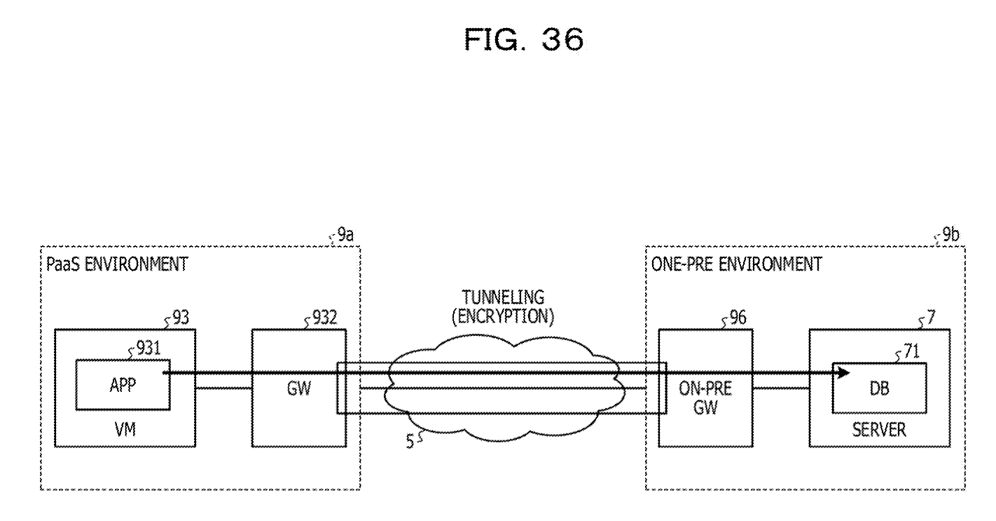

The connection configuration illustrated in FIG. 36 has a problem in which a GW 932 to which the app 931 is connected is specified as a communication destination on the app 931 and, when the app 931 is deployed, the description of the app 931 is changed in accordance with the GW 932 connected thereto.

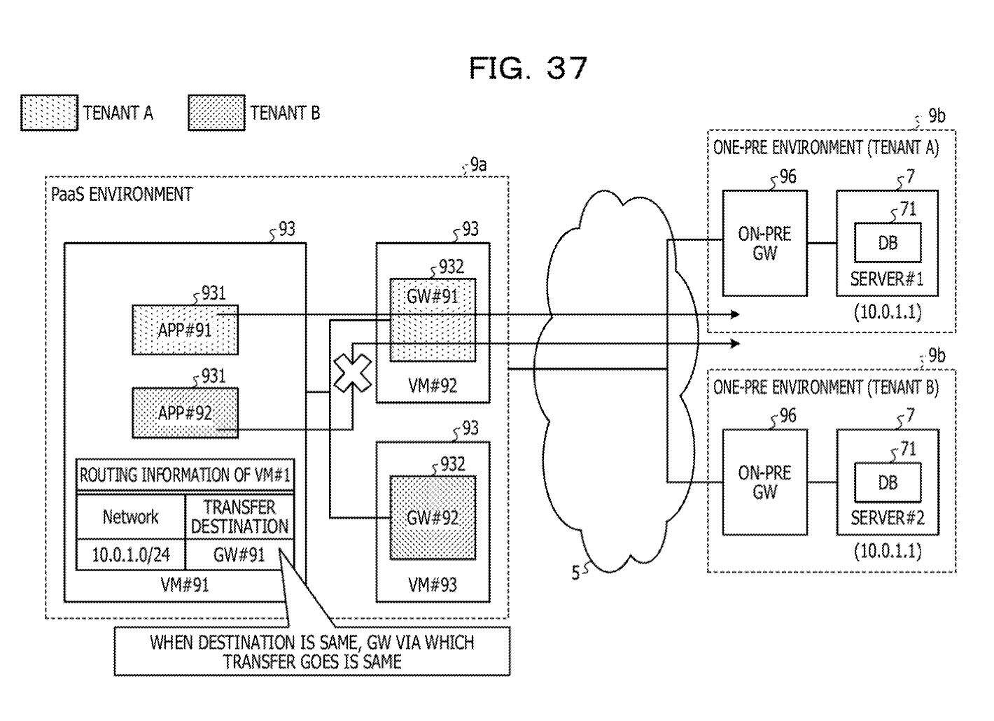

FIG. 37 is a diagram illustrating a reason why the description of the app 931 is changed. In FIG. 37, APP#91 and APP#92 of different tenants operate in VM#91, APP#91 communications with SERVER#1 via GW#91 that operates in VM#92, and APP#92 communicates with SERVER#2 via GW#92 that operates in VM#93. In this case, each of VM#91, VM#92, and VM#93 is the VM 93, each of APP#91 and APP#92 is the app 931, each of GW#91 and GW#92 is the GW 932, and each of SERVER#1 and SERVER#2 is the server 7. The IP address of SERVER#1 and the IP address of SERVER#2 are the same, that is, 10.0.1.1.

In this case, the IP addresses of destinations of a packet that is transmitted by APP#91 and a packet that is transmitted by APP#92 are the same, and therefore, a transfer destination that corresponds to 10.0.1.0/24 of routing information of VM#91 is the same, that is, the GW 932. In FIG. 37, for example, a transfer destination is GW#91. Accordingly, the packet that is transmitted by APP#92 is transferred to GW#91, and APP#92 is not capable of performing a normal communication. Therefore, the GW 932 that is connected thereto is specified as a communication destination by the app 931, and the description of the app 931 is changed.

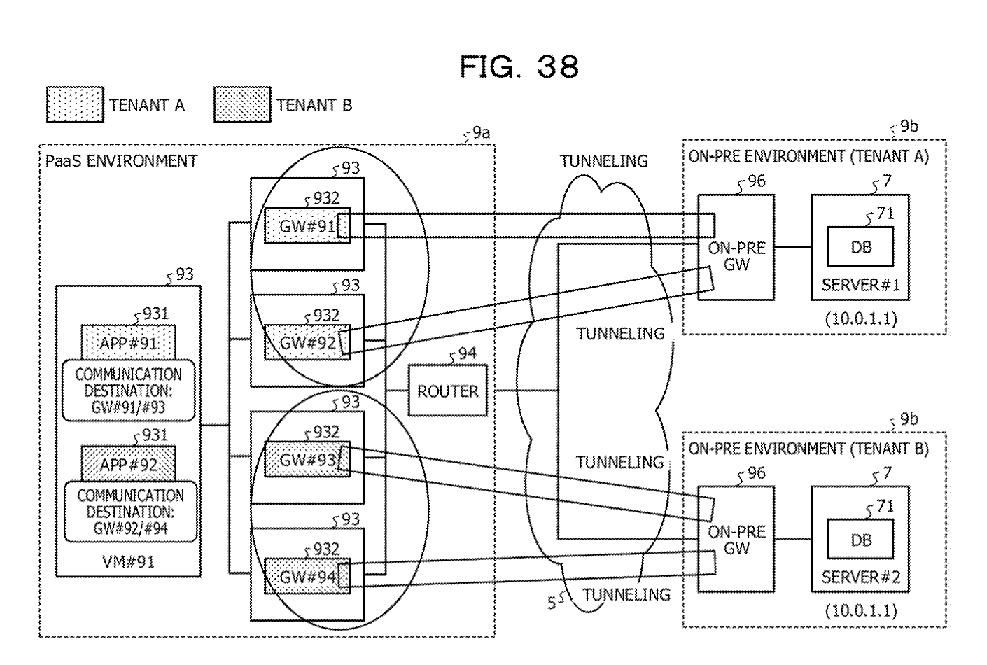

Note that, even when source routing is performed, transmission source addresses are the same, that is, the IP address of VM#91, and therefore, distribution to GW#91 and GW#92 is not possible. Also, when GW#91 and GW#92 are realized on different VMs 93, the number of the VMs 93 is increased. FIG. 38 is a diagram illustrating a case where the VM 93 that serves as a gateway is constructed for each tenant.

As illustrated in FIG. 38, the GW 932 is made redundant. That is, communication destinations of APP#91 are GW#91 and GW#93 and communication destinations of APP#92 are GW#92 and GW#94. Therefore, when the VM 93 that serves as a gateway is constructed for each tenant, twice as many VMs 93 as the number of different tenants are constructed.

Each GW 932 transmits a packet to the outside of the PaaS environment 9a via a router 94. In this case, the router 94 converts a private IP address of each GW 932 that is a transmission source to a global IP address. On the other hand, when the router 94 receives a packet from the outside, the router 94 converts the global IP address to a private IP address of each GW 932 that is a transmission destination. The on-pre GW 96 sets a global IP address that corresponds to each GW 932 as a connection destination of a tunnel. Therefore, as the number of the VMs 93 that serve as gateways is increased, the number of global IP addresses is increased.

In an aspect, it is an object of the present disclosure to achieve a configuration in which the description of an app is changed.

Embodiments for a communication control program, a communication control method, and a communication control device disclosed herein will be described in detail below with reference to the accompanying drawings. Note that the embodiments are not intended to limit the technology disclosed herein.

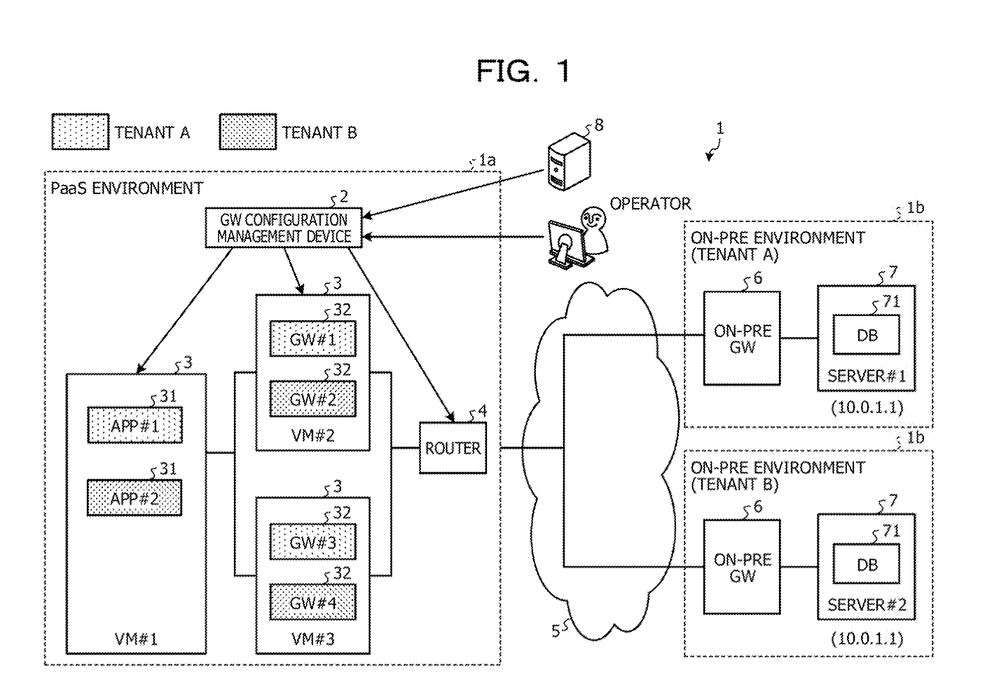

First, a configuration of a hybrid cloud type PaaS system according to an embodiment will be described. FIG. 1 is a diagram illustrating a configuration of a hybrid cloud type PaaS system according to the embodiment. As illustrated in FIG. 1, a hybrid cloud type PaaS system 1 according to the embodiment includes a PaaS environment 1a and two on-pre environments 1b. The PaaS environment 1a and the two on-pre environments 1b are connected via the Internet 5. Note that, in FIG. 1, the number of different tenants is two, and therefore, two on-pre environments 1b are illustrated, but, if the number of different tenants is three or more, the hybrid cloud type PaaS system 1 includes three or more on-pre environments 1b.

The PaaS environment 1a is an environment in a cloud and provides a PaaS. The on-pre environment 1b is an information processing environment that the tenant has. FIG. 1 illustrates an on-pre environment 1b for a tenant A and an on-pre environments 1b for a tenant B. The PaaS environment 1a and the on-pre environments 1b connected via the Internet 5 provide a hybrid cloud type PaaS.

In the PaaS environment 1a includes a GW configuration management device 2, three VMs 3 denoted by VM#1 to VM#3, and a router 4, and each of the on-pre environments 1b includes an on-pre GW 6 and a server 7.

The GW configuration management device 2 is a device that performs GW management, management of information that is set for the VMs 3 and the router 4, or the like, based on an instruction made by a PaaS management device 8 that manages the PaaS environment 1a or an operator of the PaaS environment 1a. The GW configuration management device 2 operates as a communication control device that controls a communication between the PaaS environment 1a and the on-pre environments 1b. Note that details of the GW configuration management device 2 will be described later.

The VWs 3 are virtual machines that perform information processing. In VM#1, apps 31 denoted by APP#1 and APP#2 operate. The apps 31 are applications. APP#1 is an application of the tenant A, and APP#2 is an application of the tenant B.

In VM #2, GWs 32 denoted by GW#1 and GW#2 operate. The GW 32 is a gateway that performs tunneling processing. In VM#3, GWs 32 denoted by GW#3 and GW#4 operate. GW#1 and GW#3 are gateways that perform tunneling processing for the tenant A, and GW#2 and GW#4 are gateways that perform tunneling processing for the tenant B. That is, the GWs 32 of a plurality of tenants are generated in a single VM 3. Therefore, the hybrid cloud type PaaS system 1, the number of VMs 3 in which gateways are constructed may be reduced.

By routing at a VM#1 side, a communication from the app 31 is set to go via VM#2 in which the GWs 32 are integrated. Since the GWs 32 are integrated in VM#2, normal communications are performed even when the communications of APP#1 and APP#2 go via VM#2. Therefore, in the hybrid cloud type PaaS system 1, a communication destination of the app 31 is not changed.

The on-pre GW 6 performs tunneling processing. The server 7 is a device that performs information processing. The server 7 for the tenant A is denoted as SERVER#1, and the server 7 for the tenant B is denoted as SERVER#2. The IP addresses of SERVER#1 and SERVER#2 are the same, that is, 10.0.1.1. The server 7 includes a DB 71. The DB 71 is a database that stores data that may not be stored in the cloud from the viewpoint of security risk.

The router 4 transmits a packet received from the GW 32 to the on-pre GW 6 via the Internet 5 and transmits a packet received from the on-pre GW 6 to the GW 32 via the Internet 5.

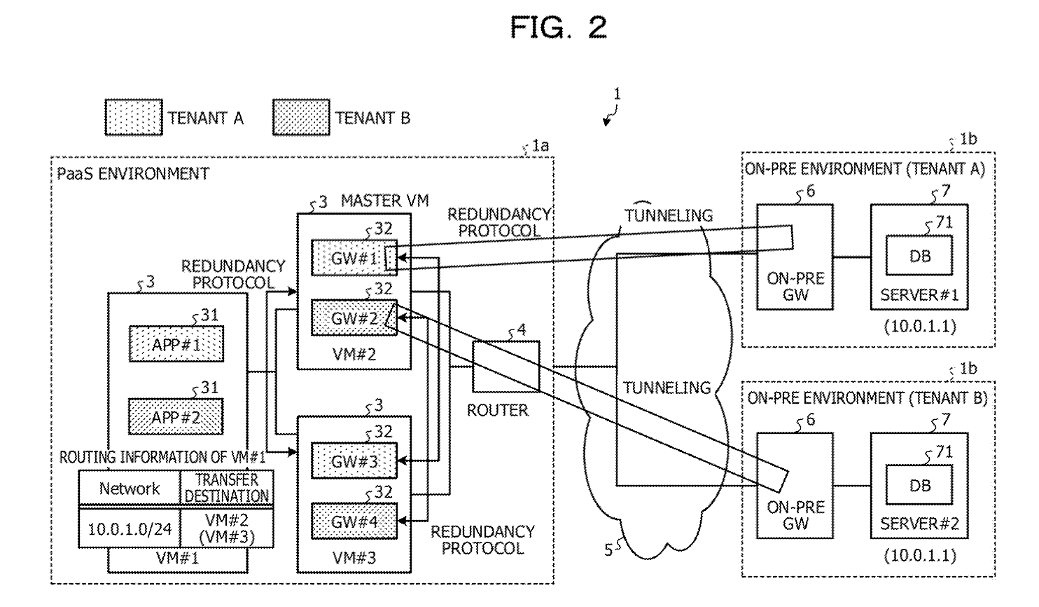

FIG. 2 is a diagram illustrating a tunneling connection of the hybrid cloud type PaaS system 1. In the hybrid cloud type PaaS system 1, a tunnel connection is performed only for the gateway on one side by control of a redundancy protocol, such as a virtual router redundancy protocol (VRRP) or the like. In FIG. 2, only for GW#1 and GW#2 constructed in VM#2, a tunnel connection with the on-pre GW 6 is performed. Therefore, in the hybrid cloud type PaaS system 1, the number of connection tunnels may be reduced, and the number of global IP addresses that are consumed may be reduced.

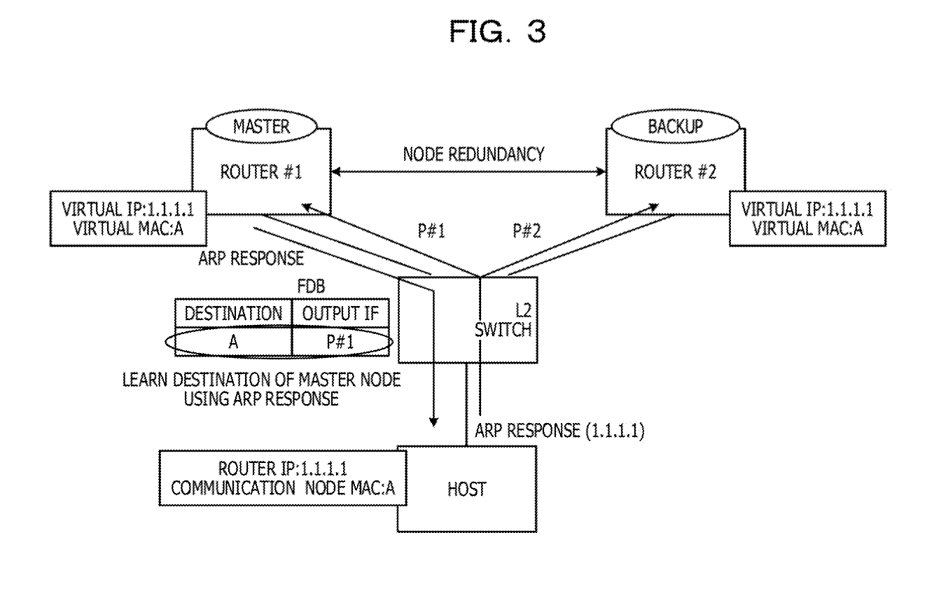

FIG. 3 is a diagram illustrating a VRRP. FIG. 3 illustrates a case where ROUTER#1 and ROUTER#2 are assumed to be nodes and ROUTER#1 and ROUTER#2 are made redundant in accordance with the VRRP. As illustrated in FIG. 3, the nodes that have been made redundant are categorized as a master and a backup. The same virtual IP address is allocated to the master and the backup. In FIG. 3, 1.1.1.1 is allocated as the virtual IP address, and A is allocated as a virtual media access control (MAC) address. Note that, in the drawings, the virtual IP address is denoted by VIRTUAL IP.

A host performs a communication with a router using a virtual IP address. Only the master node responses to an address resolution protocol (ARP) request of the host, and thereby, an L2 switch learns a path P#1 toward the master node and registers the path P#1 in a forwarding database (FDB). When the host transmits data to the router using the virtual IP address, the L2 switch transfers data to the master node. In FIG. 2, packets transmitted from APP#1 and APP#2 are transferred to VM#2, which is a master node, based on routing information.

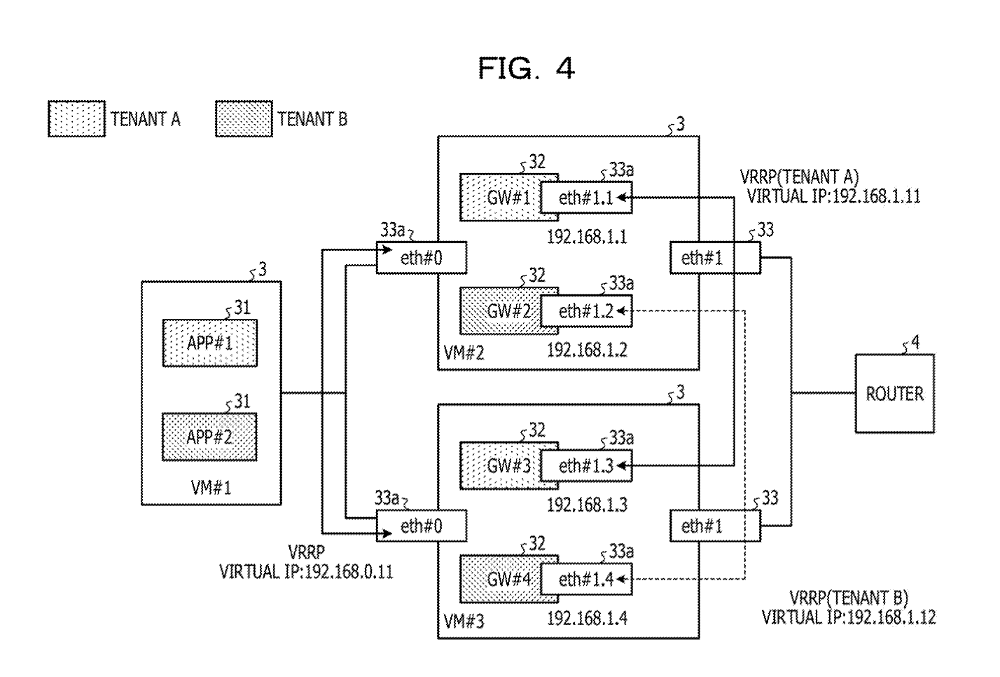

FIG. 4 is a diagram illustrating a redundant configuration of a gateway. As illustrated in FIG. 4, the hybrid cloud type PaaS system 1 uses the VRRP between the GWs 32. Between the app 31 and the GW 32, redundancy is performed in units of VM 3. That is, the same virtual IP address is allocated to eth#0, which is a virtual interface 33a of each of VM#2 and VM#3 at the app 31 side, in accordance with the VRRP. In FIG. 4, the virtual IP address of eth#0 is 192.168.0.11.

On the other hand, between the GW 32 and the router 4, redundancy is performed in units of GWs 32. That is, the same virtual IP address for the tenant A is allocated to eth#1.1, which is a virtual interface 33a of GW#1 at the router 4 side and eth#1.3, which is a virtual interface 33a of GW#3 at the router 4 side in accordance with the VRRP. In FIG. 4, the virtual IP addresses of eth#1.1 and eth#1.3 are 192.168.1.11. The same virtual IP address for the tenant B is allocated to eth#1.2, which is a virtual interface 33a of GW#2 at the router 4 side 2, and eth#1.4, which is a virtual interface 33a of GW#4 at the router 4 side in accordance with the VRRP. In FIG. 4, the virtual IP addresses of eth#1.2 and eth#1.4 are 192.168.1.12.

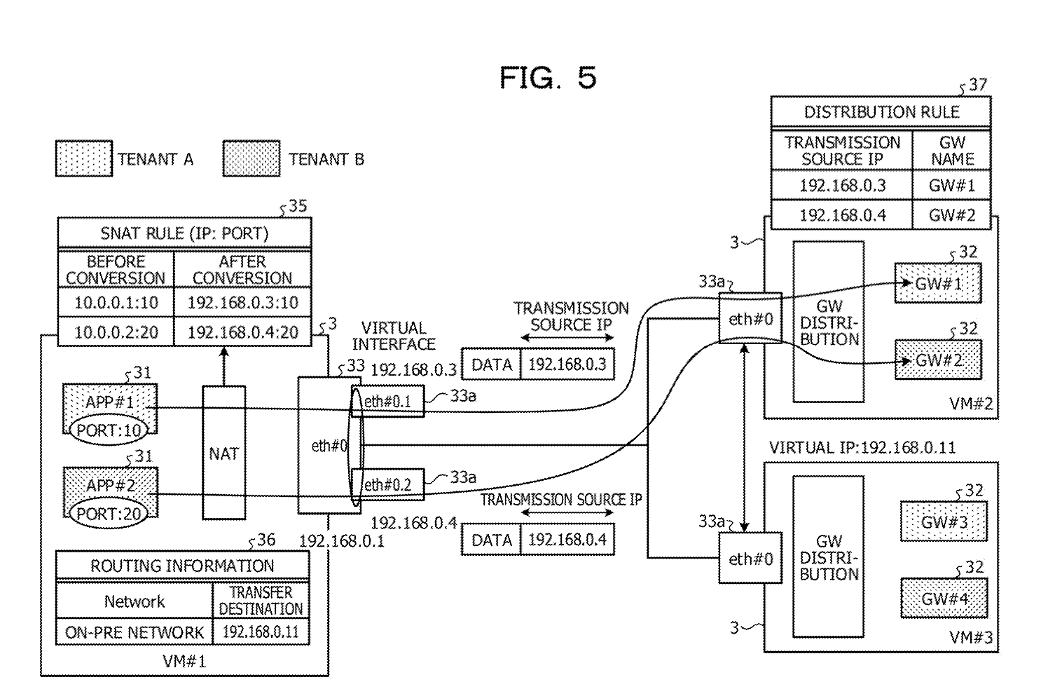

FIG. 5 is a diagram illustrating a connection between the app 31 and the GW 32. As illustrated in FIG. 5, in VM#1 in which the apps 31 are deployed, a virtual IP address that is converted by source network address translation (SNAT) is set for the virtual interface 33a generated for each tenant. In FIG. 5, 192.168.0.3 is set for the virtual interface 33a for the tenant A, and 192.168.0.4 is set for the virtual interface 33a for the tenant B.

The virtual IP addresses that have been set are registered as transmission source addresses after conversion in a NAT table 35. Therefore, the transmission source IP addresses of packets transmitted to an on-pre network by the apps 31 are 192.168.0.3 In APP#1 and 192.168.0.4 in APP#2.

In VM#1, as a VM address of a relay destination of a communication to the on-pre network, the virtual IP addresses set for VM#2 and VM#3 are registered in a routing table 36. In FIG. 5, 192.168.0.11 is registered in association with the on-pre network in the routing table 36. The VM 3 that relays a communication is controlled in accordance with the VRRP. In FIG. 5, VM#2 operates as a master node, and a packet transmitted to the on-pre network by the app 31 is transferred to VM#2.

In VM#2, the GW 32 of a distribution destination, which corresponds to the transmission source IP address, is registered in a distribution rule table 37, and the GW 32 of the distribution destination is determined based on the transmission source IP address. In FIG. 5, a packet the transmission source IP address of which is 192.168.0.3 is distributed to GW#1, and a packet the transmission source IP address of which is 192.168.0.4 is distributed to GW#2.

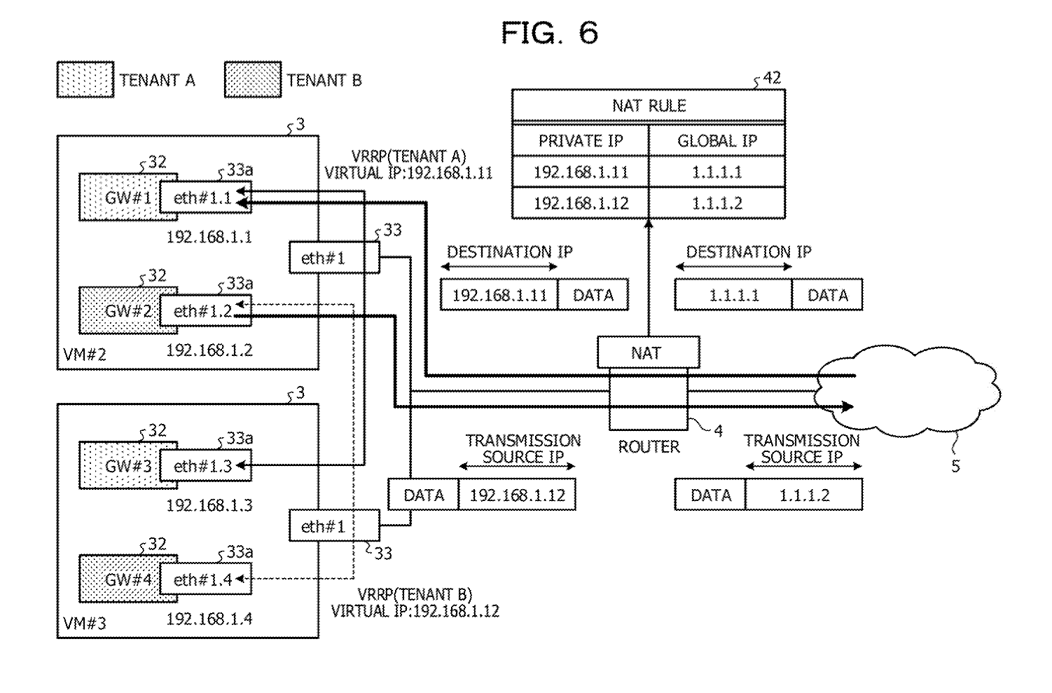

FIG. 6 is a diagram illustrating a connection between the GW 32 and the Internet 5. As illustrated in FIG. 6, the router 4 performs conversion of a private IP address and a global IP address using a NAT table 42.

For example, when the router 4 receives a packet the destination IP address is 1.1.1.1 from the Internet 5, the router 4 refers to the NAT table 42, converts the destination IP address to 192.168.1.11, and transmits the packet to GW#1. When the router 4 receives a packet the transmission source IP address is 192.168.1.12 from GW#2, the router 4 refers to the NAT table 42, converts the transmission source IP address to 1.1.1.2, and transmits the packet to the Internet 5.

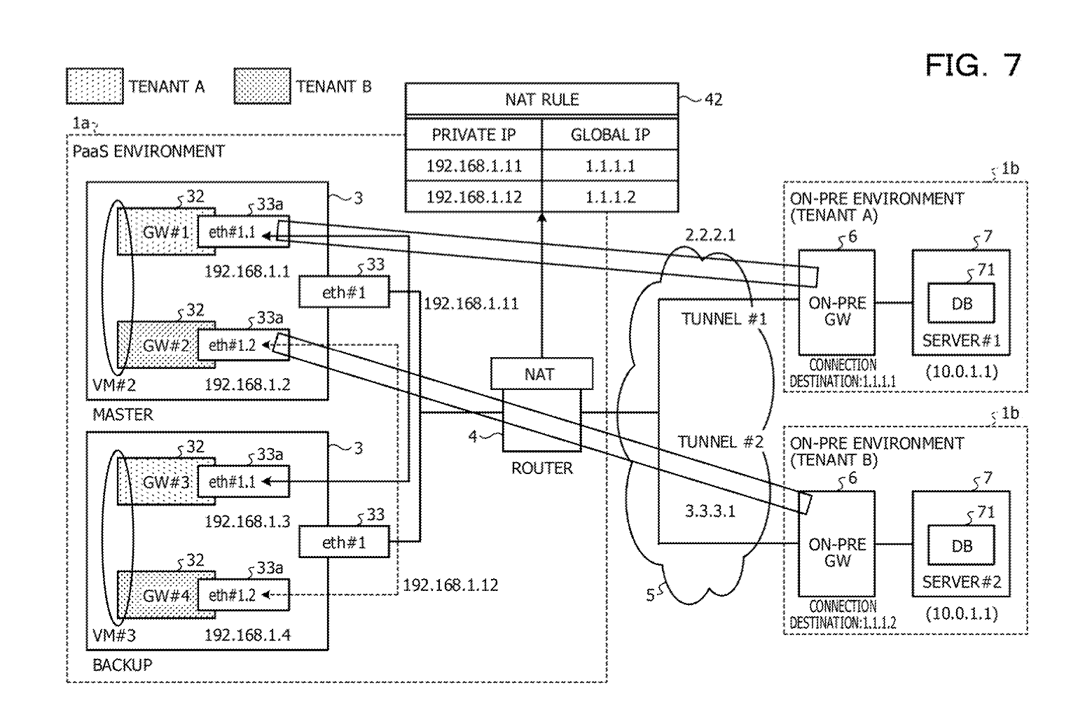

FIG. 7 is a diagram illustrating a tunneling connection between the GW 32 and the on-pre GW 6. As illustrated in FIG. 7, in TUNNEL#1 for the tenant A, the IP address of a connection destination of the on-pre GW 6 is the global IP address (1.1.1.1) that corresponds to the virtual IP address (192.168.1.11) of GW#1 and GW#3 for the tenant A. In TUNNEL#2 for the tenant B, the IP address of a connection destination of the on-pre GW 6 is the global IP address (1.1.1.2) that corresponds to the virtual IP address (192.168.1.12) of GW#2 and GW#4 for the tenant B.

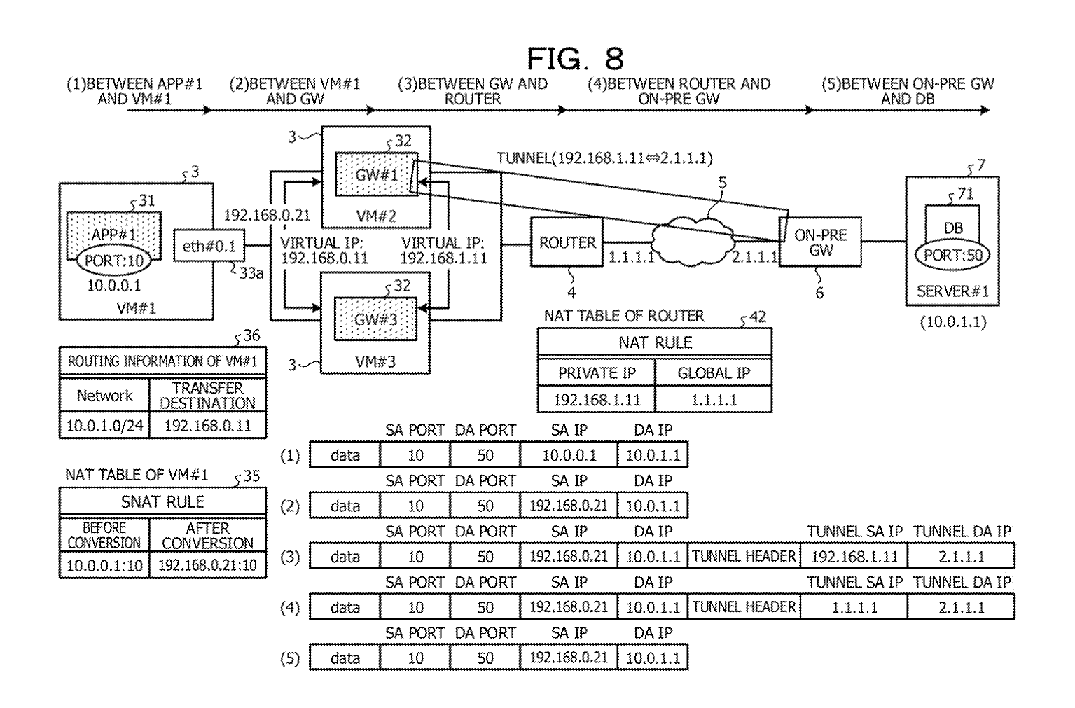

Next, a flow of packet address translation and related processing will be described with reference to FIG. 8 to FIG. 11B. FIG. 8 is a diagram illustrating a flow (the app 31→the DB 71) of packet address translation. Note that a SA port is a port number of a transmission source, a DA port is a port number of a transmission destination, an SA IP is an IP address of a transmission source, and a DA IP is an IP address of a transmission destination.

As illustrated in FIG. 8, in a packet (1) that is transmitted from APP#1 to VM#1, the SA IP is 10.0.0.1, which is an IP address set for a container of APP#1. A container herein is an environment in which the app 31 is executed. The DA IP is 10.0.1.1, which is an IP address set for SERVER#1.

In a packet (2) that is transmitted from VM#1 to the GW 32, based on a NAT table 35 of VM#1, the SA IP is converted to 192.168.0.21, which is a virtual IP address set for the virtual interface 33a of VM#1, by VM#1.

In a packet (3) that is transmitted from the GW 32 to the router 4, a tunnel header, a tunnel SA IP, and a tunnel DA IP are added by the GW 32. The tunnel SA IP is 192.168.1.11, which is the virtual IP address set for GW#1 and GW#3. The tunnel DA IP is 2.1.1.1, which is the global IP address set for the on-pre GW 6.

In a packet (4) that is transmitted from the router 4 to the on-pre GW 6, the tunnel SA IP is converted to 1.1.1.1, which is the global IP address, by the router 4, based on a NAT table 42 of the router 4.

In a packet (5) that is transmitted from the on-pre GW 6 to the DB 71, the tunnel header, the tunnel SA IP, and the tunnel DA IP are removed by the on-pre GW 6.

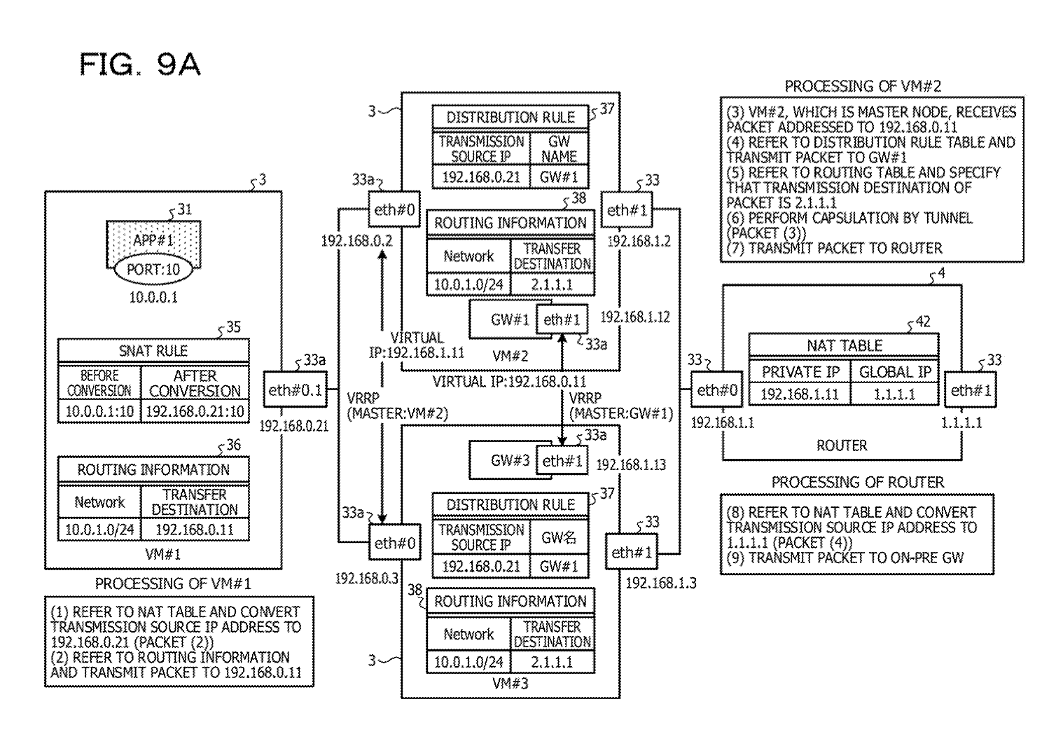

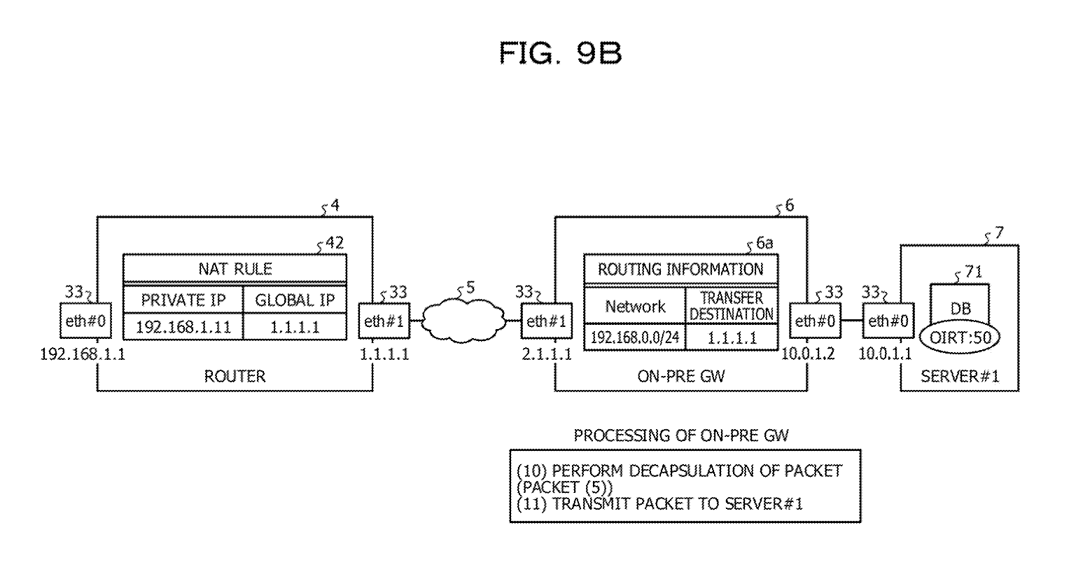

Each of FIG. 9A and FIG. 9B is a diagram illustrating processing (the app 31→the DB 71) that is performed on a packet. As illustrated in FIG. 9A, VM#1 refers to the NAT table 35 and converts the transmission source IP address of a packet transmitted from APP#1 to 192.168.0.21 (1). The converted packet is a packet illustrated in (2) of FIG. 8. Then, VM#1 refers to the routing table 36 and transmits the packet to 192.168.0.11 (2).

VM#2, which is a master node, receives the packet addressed to 192.168.0.11 (3). VM#2 that has received the packet refers to the distribution rule table 37 and transmits the packet to GW#1 (4).

GW#1 that has received the packet refers to a routing table 38 and specifies that the transmission destination of the packet is 2.1.1.1 (5). Then, GW#1 performs capsulation by a tunnel. The capsulated packet is a packet illustrated in (3) of FIG. 8. Then, GW#1 transmits the packet to the router 4 (7).

The router 4 that has received the packet refers to the NAT table 42 and converts a transmission IP address of the tunnel to 1.1.1.1 (8). The converted packet is a packet illustrated in (4) of FIG. 8. Then, the router 4 transmits the packet to the on-pre GW 6 (9).

As illustrated in FIG. 9B, the on-pre GW 6 that has received the packet performs decapsulation of the packet (10). The decapsulated packet is a packet illustrated in (5) of FIG. 8. Then, the on-pre GW 6 transmits the packet to SERVER#1 (11).

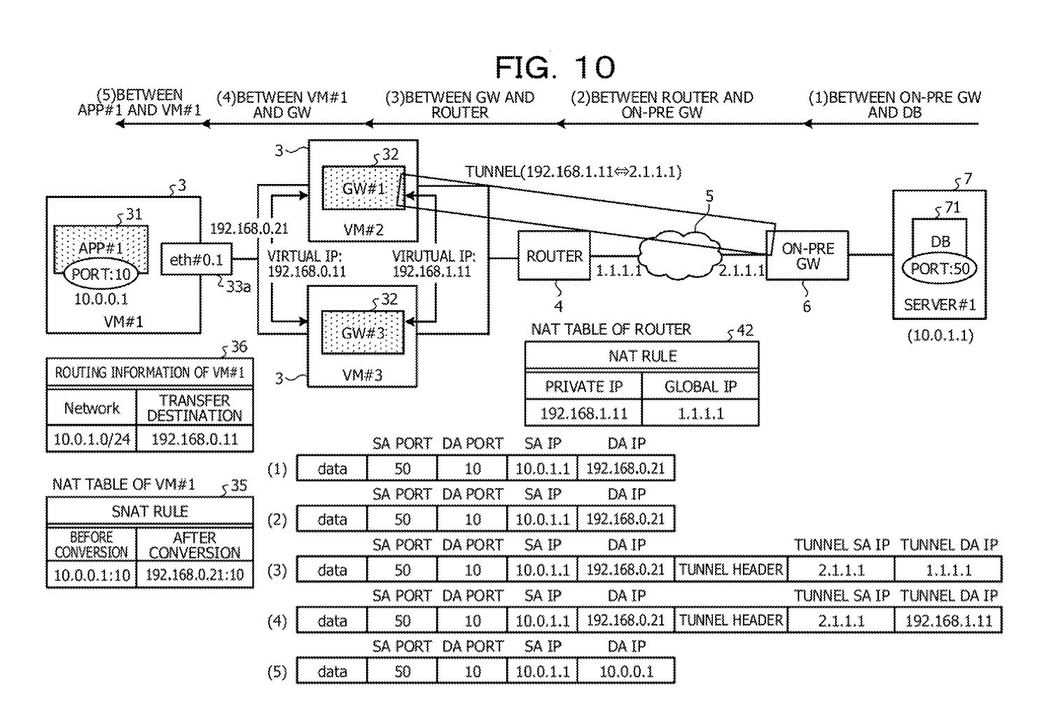

FIG. 10 is a diagram illustrating a flow (the DB 71→the app 31) of packet address translation. As illustrated in FIG. 10, the packet (1) that is transmitted from the DB 71 to the on-pre GW 6, the SA IP is 10.0.1.1, which is the IP address set for SERVER#1. The DA IP is 192.168.0.21, which is the virtual IP address set for the virtual interface 33a of VM#1.

In the packet (2) that is transmitted from the on-pre GW 6 to the router 4, the tunnel header, the tunnel SA IP, and the tunnel DA IP are added by the on-pre GW 6. The tunnel SA IP is 2.1.1.1, which is the global IP address set for the on-pre GW 6. The tunnel DA IP is 1.1.1.1, which is the global IP address set for the router 4.

In the packet (3) that is transmitted from the router 4 to GW#1, the tunnel DA IP is converted to 192.168.1.11, which is a private IP address, by the router 4, based on the NAT table 42 of the router 4.

In the packet (4) that is transmitted from GW#1 to VM#1, the tunnel header, the tunnel SA IP, and the tunnel DA IP are removed by GW#1.

In the packet (5) that is transmitted from VM#1 to APP#1, the DA IP is converted to 1.0.0.0.1, which is an IP address set for the container of APP#1, by VM#1, based on the NAT table 35 of VM#1.

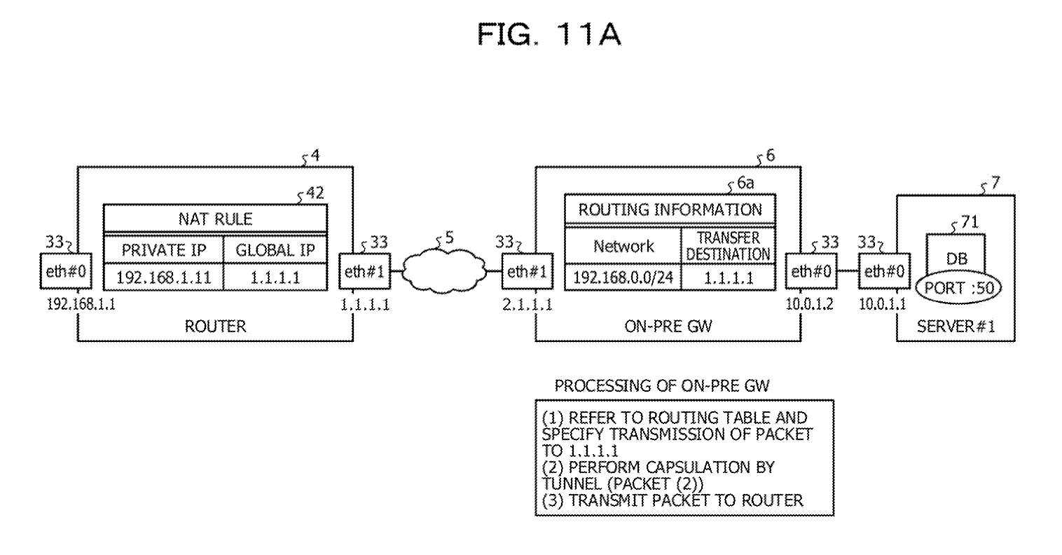

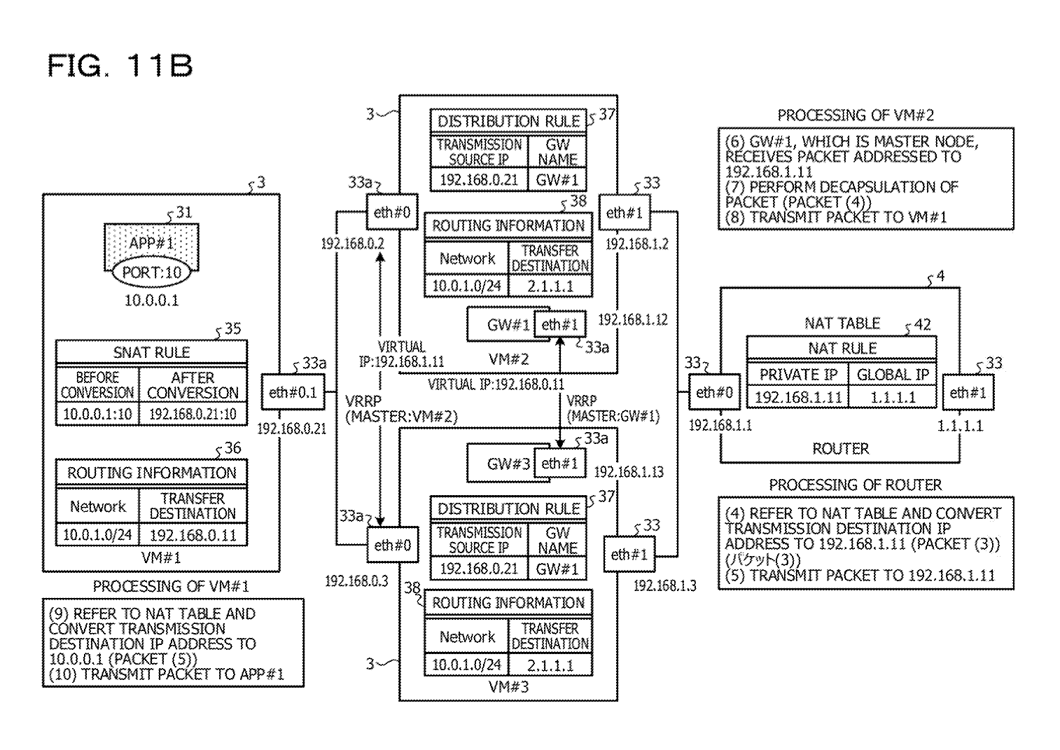

Each of FIG. 11A and FIG. 11B is a diagram illustrating processing (the DB 71→the app 31) that is performed on a packet. As illustrated in FIG. 11A, the on-pre GW 6 refers to a routing table 6a and specifies transmission of a packet to 1.1.1.1 (1). Then, the on-pre GW 6 performs capsulation by a tunnel (2). The capsulated packet is a packet illustrated in (2) of FIG. 10. Then, the on-pre GW 6 transmits the packet to the router 4 (3).

As illustrated in FIG. 11B, the router 4 that has received the packet refers to the NAT table 42 and converts the transmission destination IP address to 192.168.1.11 (4). The converted packet is a packet illustrated in (3) of FIG. 10. Then, the router 4 transmits the packet to 192.168.1.11 (5).

GW#1, which is a master node, receives the packet addressed to 192.168.1.11 (6). Then, GW#1 performs decapsulation of the packet (7). The decapsulated packet is a packet illustrated in (4) of FIG. 10. Then, GW#1 transmits the packet to VM#1 (8).

VM#1 that has received the packet refers to the NAT table 35 and converts the transmission destination IP address to 10.0.0.1 (9). The converted packet is a packet illustrated in (5) of FIG. 10. Then, VM#1 transmits the packet to APP#1 (10).

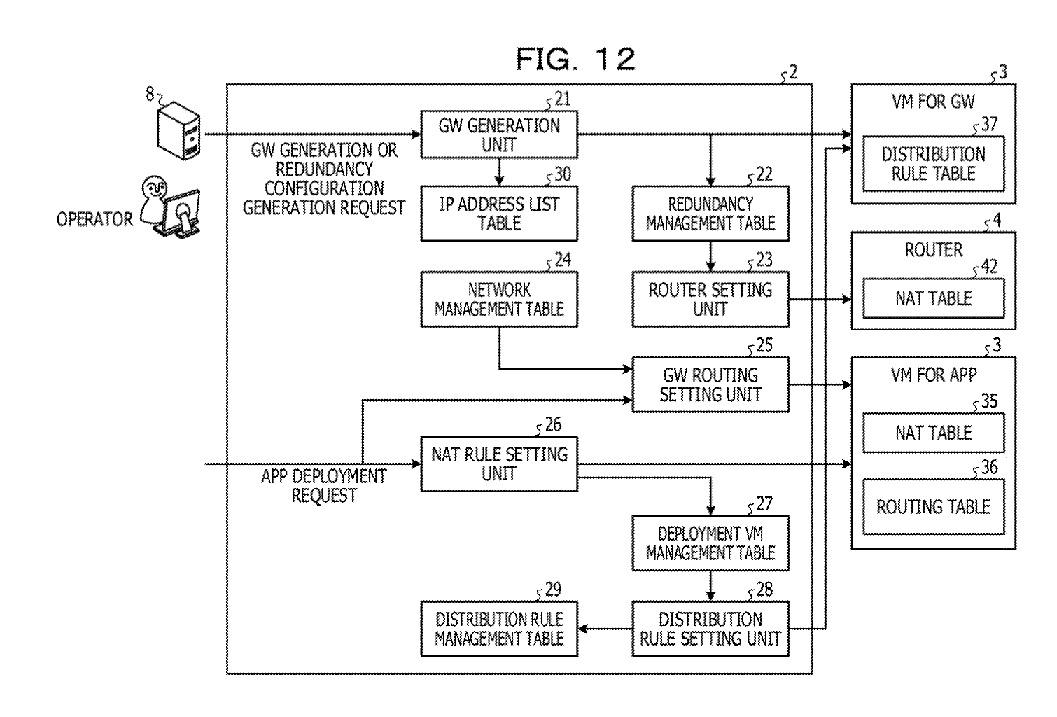

Next, a functional configuration of the GW configuration management device 2 will be described. FIG. 12 is a diagram illustrating a functional configuration of the GW configuration management device 2. As illustrated in FIG. 12, the GW configuration management device 2 includes a GW generation unit 21, a redundancy management table 22, a router setting unit 23, a network management table 24, a GW routing setting unit 25, a NAT rule setting unit 26, and a deployment VM management table 27. Also, the GW configuration management device 2 includes a distribution rule setting unit 28, a distribution rule management table 29, and an IP address list table 30.

The GW generation unit 21 receives a redundant configuration generation request for the VM 3 from the PaaS management device 8 or the operator, generates a redundant configuration of the VM 3 in which the GW 32 is generated, and registers information related to the generated VM 3 in the redundancy management table 22. A redundant configuration generation request herein is a request for generating a VM 3 of a redundant configuration for the GW 32.

Also, the GW generation unit 21 receives a GW generation request from the PaaS management device 8 or the operator, generates a GW 32, and also performs setting of redundancy. Specifically, the GW generation unit 21 makes the GW 32 redundant in accordance with the VRRP, and sets a virtual IP address for a master GW 32 and a backup GW 32. Then, the GW generation unit 21 generates a NAT rule in which the virtual IP address set for the master GW 32 and the backup GW 32 is converted to a global IP address. Also, the GW generation unit 21 makes a GW VM 3 redundant, sets a virtual IP address, and sets the set virtual IP address as a transfer destination of routing information of an app VM 3. Then, the GW generation unit 21 updates the redundancy management table 22 using information related to the generated GW 32.

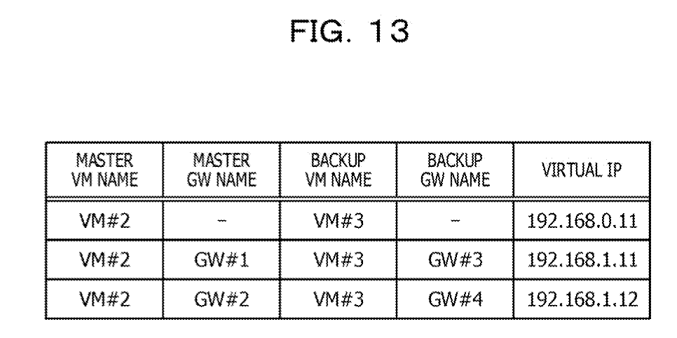

The redundancy management table 22 is a table in which information related to the VM 3 and the GW 32 of a redundant configuration is registered. FIG. 13 is a table illustrating an example of the redundancy management table 22. As illustrated in FIG. 13, in the redundancy management table 22, a master VM name, a master GW name, a backup VM name, a backup GW name, and a virtual IP are registered in association with one another.

The master VM name is the name of the VM 3 that operates as a master. The master GW name is the name of the GW 32 that is generated in the master VM 3. The backup VM name is the name of the VM 3 that operates as a backup. The backup GW name is the name of the GW 32 that is generated in the backup VM 3. The virtual IP is a virtual IP address that is set for a set of the master VM 3 and the backup VM and a set of the master GW 32 and the backup GW 32.

For example, the virtual IP address set for a set of VM#2 that operates as a master and VM#3 that operates as a backup is 192.168.0.11. Also, the virtual IP address set for a set of GW#1 that operates as a master in VM#2 and GW#3 that operates as a backup in VM#3 is 192.168.1.11.

The router setting unit 23 sets the NAT rule generated by the GW generation unit 21 in the NAT table 42 of the router 4.

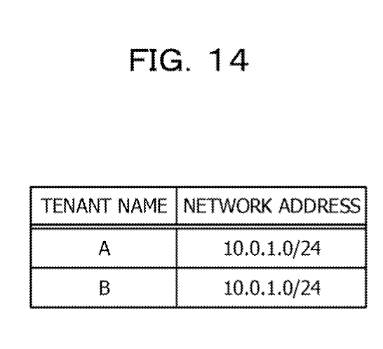

The network management table 24 is a table in which a network of a tenant is registered. FIG. 14 is a table illustrating an example of the network management table 24. As illustrated in FIG. 14, in the network management table 24, a tenant name and a network address are registered in association with one another. The tenant name is the name of a tenant. The network address is an IP address and a subnet mask of the on-pre environments 1b. For example, the IP address and the subnet mask of the on-pre environment 1b of the tenant A is 10.0.1.0/24.

The GW routing setting unit 25 generates routing information of the app VM 3, that is, the VM 3 in which the app 31 is deployed, and sets the routing information in the routing table 36 of the app VM 3. The GW routing setting unit 25 generates routing information using the network address registered in the network management table 24.

The NAT rule setting unit 26 generates the virtual interface 33a for each tenant in the app VM 3, and sets the virtual IP address. Then, the NAT rule setting unit 26 generates an SNAT rule of the app VM 3 using the set virtual IP address and registers the SNAT rule in the deployment VM management table 27. Also, the NAT rule setting unit 26 sets the generated SNAT rule in the NAT table 35 of the app VM 3.

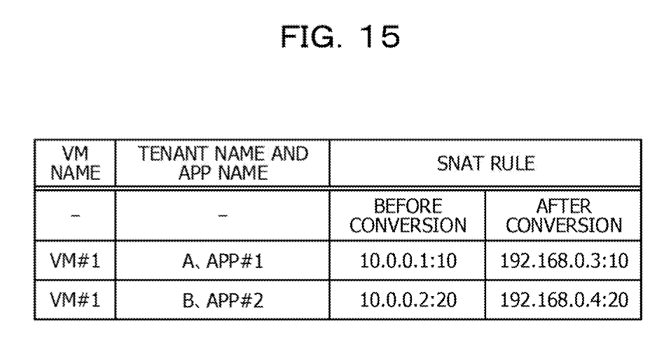

The deployment VM management table 27 is a table in which the app 31 that is deployed in the app VM 3 and the SNAT rule that is set for the app VM 3 are registered. FIG. 15 is a table illustrating an example of the deployment VM management table 27. As illustrated in FIG. 15, in the deployment VM management table 27, a VM name, a tenant name, an app name, and an SNAT rule are registered in association with one another.

The VM name is the name of the VM 3 in which the app 31 is deployed. The tenant name and the app name are the name of a tenant of the app 31, which is executed in the VM 3, and the name of the app 31, respectively. The SNAT rule is a rule of SNAT, which is set for the VM 3. For example, APP#1 of the tenant A is deployed in VM#1, and the transmission source IP address of a packet transmitted by APP#1 is converted from 10.0.0.1 to 192.168.0.3.

The distribution rule setting unit 28 generates a distribution rule for the GW VM 3, that is, the VM 3 in which the GW 32 is generated, and registers the distribution rule in the distribution rule management table 29. Also, the distribution rule setting unit 28 sets the generated distribution rule in the distribution rule table 37 of the GW VM 3.

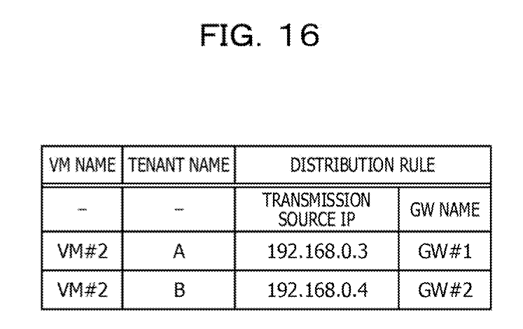

The distribution rule management table 29 is a table used by the distribution rule setting unit 28 for managing the distribution rule. FIG. 16 is a table illustrating an example of the distribution rule management table 29. As illustrated in FIG. 16, in the distribution rule management table 29, a VM name, a tenant name, and a distribution rule are registered in association with each other.

The VM name is the name of the VM 3 for which the distribution rule is set. The tenant name is the name of a tenant to which the distribution rule is applied. The distribution rule is a rule in which the transmission source IP address indicates the GW 32 of a packet distribution destination indicated in the transmission source IP. For example, VM#2 that has received a packet of the tenant A the transmission source IP address is 192.168.0.3 distributes the packet to GW#1.

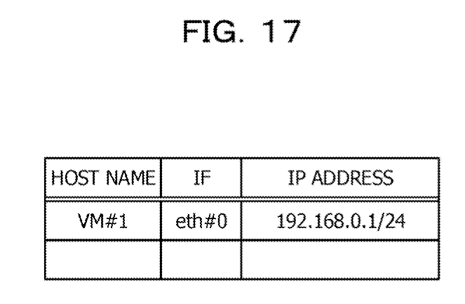

The IP address list table 30 is a table in which an IP address or a virtual IP address, which is set for an interface 33 or the virtual interface 33a, is registered. FIG. 17 is a table illustrating an example of the IP address list table 30. As illustrated in FIG. 17, in the IP address list table 30, a host name, an IF, and an IP address are registered in association with one another.

The host name is the name of the VM 3 in which the interface 33 or the virtual interface 33a is generated. The IF is the name of the interface 33 or the virtual interface 33a. The IP address is an IP address and a subnet mask set for the interface 33, or a virtual IP address and a subnet mask set for the virtual interface 33a. For example, eth#0 is an interface generated in VM#1, and the IP address and the subnet mask is 192.168.0.1/24.

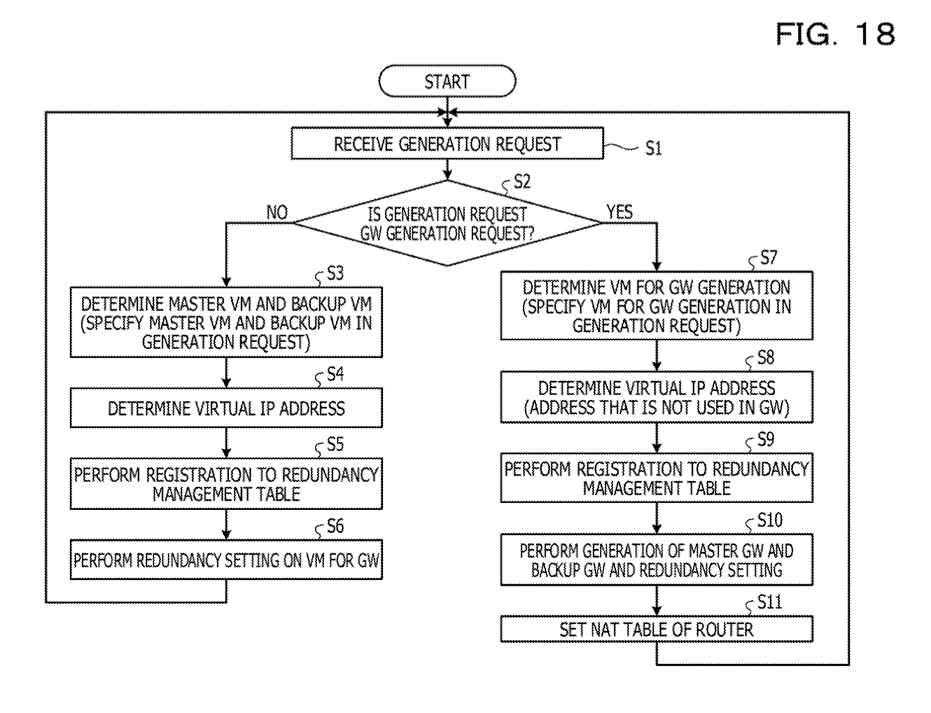

Next, a flow of processing that is performed on a GW generation request and a redundant configuration generation request will be described. FIG. 18 is a flowchart illustrating a flow of processing that is performed on a GW generation request and a redundant configuration generation request. As illustrated in FIG. 18, the GW generation unit 21 receives a generation request (Step S1) and determines whether or not the received generation request is a GW generation request (Step S2). In this case, the generation request is one of a GW generation request and a redundant configuration generation request.

If the received generation request is not a GW generation request, the GW generation unit 21 determines a master VM 3 and a backup VM 3 (Step S3). Note that the master VM 3 and the backup VM 3 are specified in the generation request. The GW generation unit 21 determines a virtual IP address that is set for the master VM 3 and the backup VM 3 (Step S4) and registers the master VM 3, the backup VM 3, and the virtual IP address in the redundancy management table 22 (Step S5). Then, the GW generation unit 21 performs a redundancy setting on the GW VM 3 (Step S6) and the process returns to Step S1.

On the other hand, if the received generation request is a GW generation request, the GW generation unit 21 determines a VM 3 for GW generation (Step S7). Note that the VM 3 for GW generation is specified in the generation request. Then, the GW generation unit 21 determines a virtual IP address for the GW 32 (Step S8). For the virtual IP address for the GW 32, an address that is not used in the GW 32 is used. Then, the GW generation unit 21 registers the master GW 32, the backup GW 32, and the virtual IP address in the redundancy management table 22 (Step S9).

The GW generation unit 21 generates, then, the master GW 32 and the backup GW 32 in the master VM 3 and the backup VM 3, respectively, and performs redundancy setting (Step S10). The router setting unit 23 sets the NAT table 42 of the router 4 (Step S11) and the process returns to S1.

As described above, the GW generation unit 21 generates the master GW 32 and the backup GW 32 in the master VM 3 and the backup VM 3, respectively, performs redundancy setting, and thereby, realizes a redundancy configuration of the GW 32.

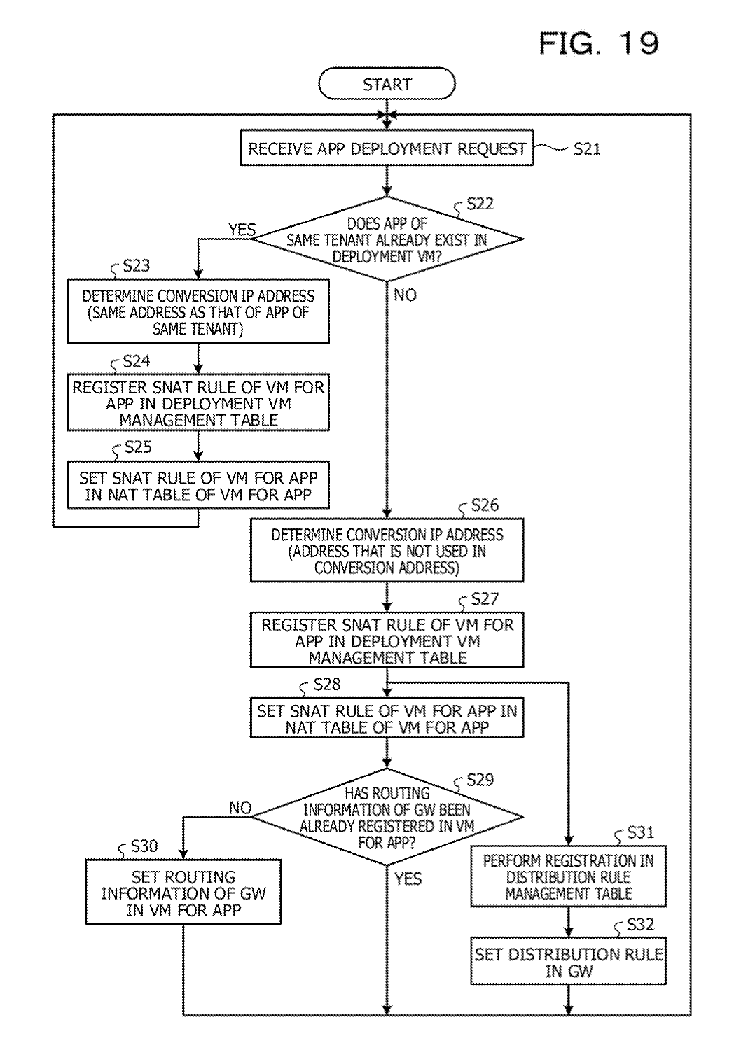

Next, a flow of processing that is performed on an app deployment request will be described. FIG. 19 is a flowchart illustrating a flow of processing that is performed on an app deployment request. As illustrated in FIG. 19, the NAT rule setting unit 26 receives an app deployment request (Step S21) and determines whether or not the app 31 of the same tenant already exists in the deployment VM 3 (Step S22).

If the app 31 of the same tenant already exists in the deployment VM 3, the NAT rule setting unit 26 determines a conversion IP address (Step S23). The conversion IP address is the same address as that of the app 31 of the same tenant. Then, the NAT rule setting unit 26 registers an SNAT rule of the app VM 3 in the deployment VM management table 27 (Step S24) and sets the SNAT rule of the app VM 3 in the NAT table 35 of the app VM 3 (Step S25). Then, the NAT rule setting unit 26 causes the process to return to Step S21.

On the other hand, if the app 31 of the same tenant does not already exist in the deployment VM 3, the NAT rule setting unit 26 determines a conversion IP address (Step S26). The conversion IP address is an address that is not used in a conversion address. Then, the NAT rule setting unit 26 registers an SNAT rule of the app VM 3 in the deployment VM management table 27 (Step S27). Then, the NAT rule setting unit 26 sets the SNAT rule of the app VM 3 in the NAT table 35 of the app VM 3 (Step S28).

The GW configuration management device 2, then, determines whether or not routing information of the GW 32 has been registered in the app VM 3 and, if the routing information of the GW 32 has been registered in the app VM 3, the process returns to Step S21. On the other hand, if the routing information of the GW 32 has not been registered in the app VM 3, the GW routing setting unit 25 sets the routing information of the GW 32 in the app VM 3 (Step S30) and the process returns to Step S21.

In parallel to the processing of Step S28 to Step S30, the distribution rule setting unit 28 registers a distribution rule of the GW 32 in the distribution rule management table 29 (Step S31) and sets the distribution rule for the GW 32 (Step S32). Then, the GW configuration management device 2 causes the process to return to Step S21.

As described above, the GW configuration management device 2 sets an SNAT rule and routing information for a app VM 3 and sets a distribution rule for the GW VM 3, and thereby, a packet transmitted from the app 31 is distributed to a proper GW 32.

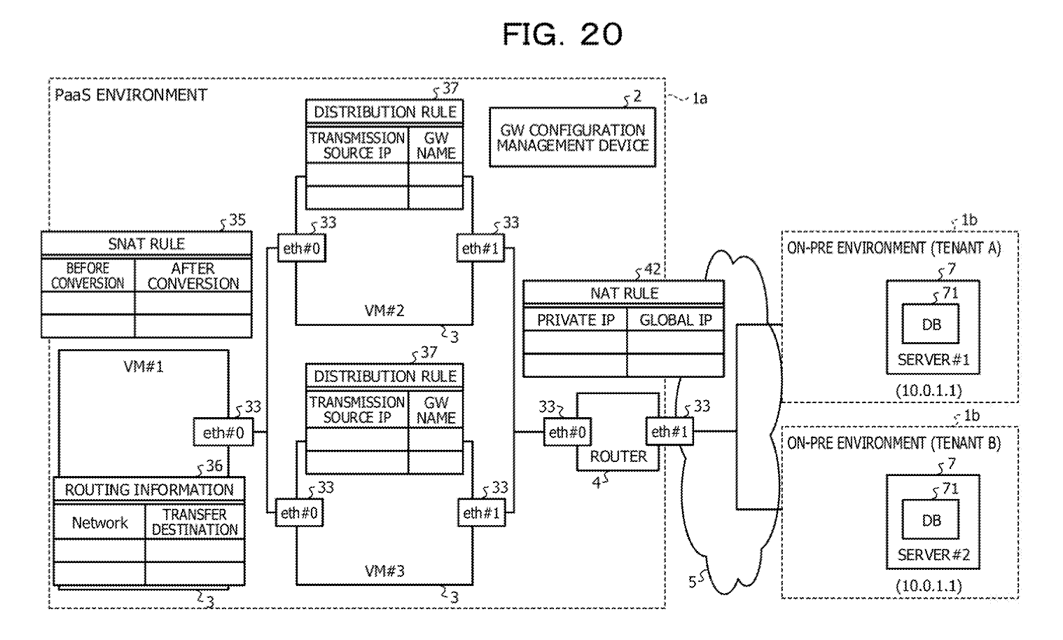

Next, an example of a construction of the GW 32 will be described with reference to FIG. 20 to FIG. 25B. FIG. 20 is a diagram illustrating an initial configuration. As illustrated in FIG. 20, in an initial state, nothing is registered in the NAT table 35 and the routing table 36 of VM#1, the distribution rule tables 37 of VM#2 and VM#3, and the NAT table 42 of the router 4.

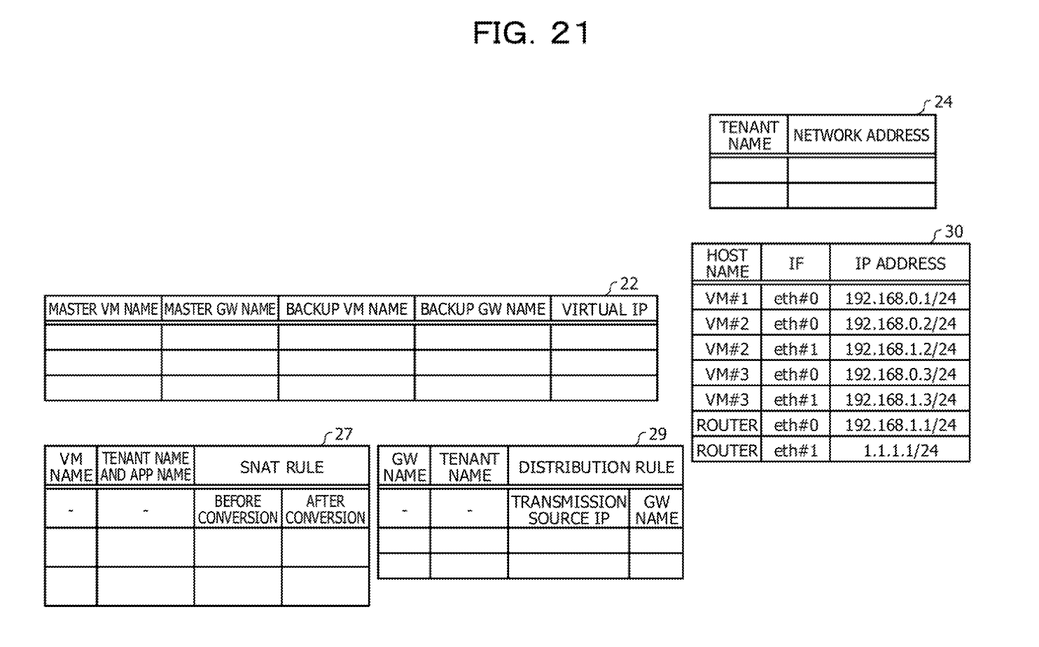

FIG. 21 is a diagram illustrating a table configuration (an initial state) in the GW configuration management device 2. As illustrated in FIG. 21, in an initial state, nothing is registered in the redundancy management table 22, the network management table 24, the deployment VM management table 27, and the distribution rule management table 29. Also, the IP address and the subnet mask of the interface 33 of VM#1 to VM#3 and the router 4 are registered in the IP address list table 30.

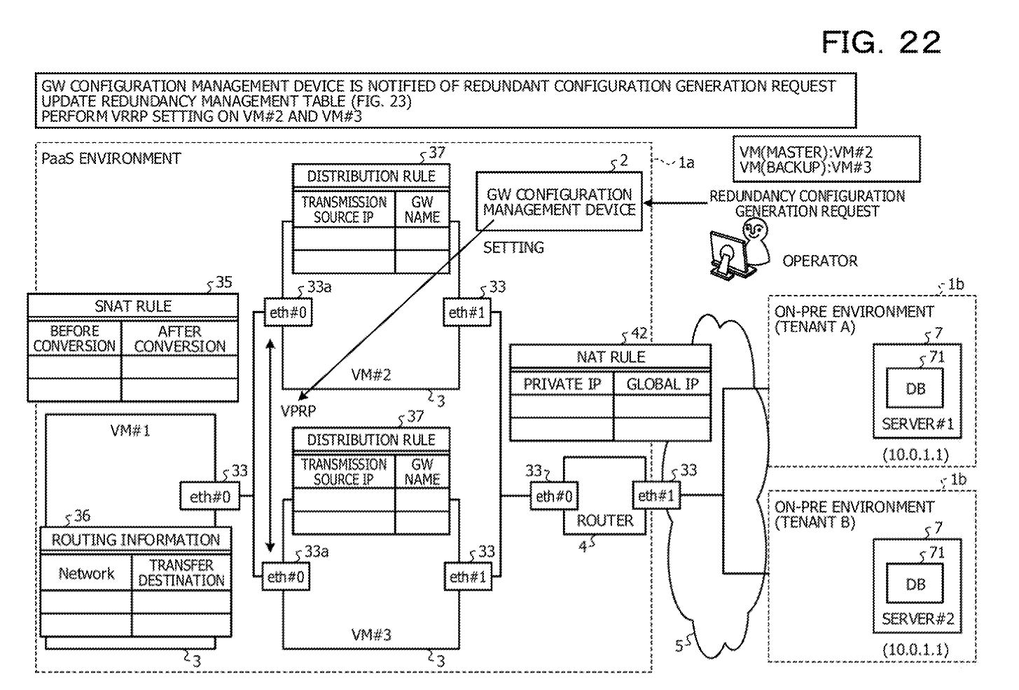

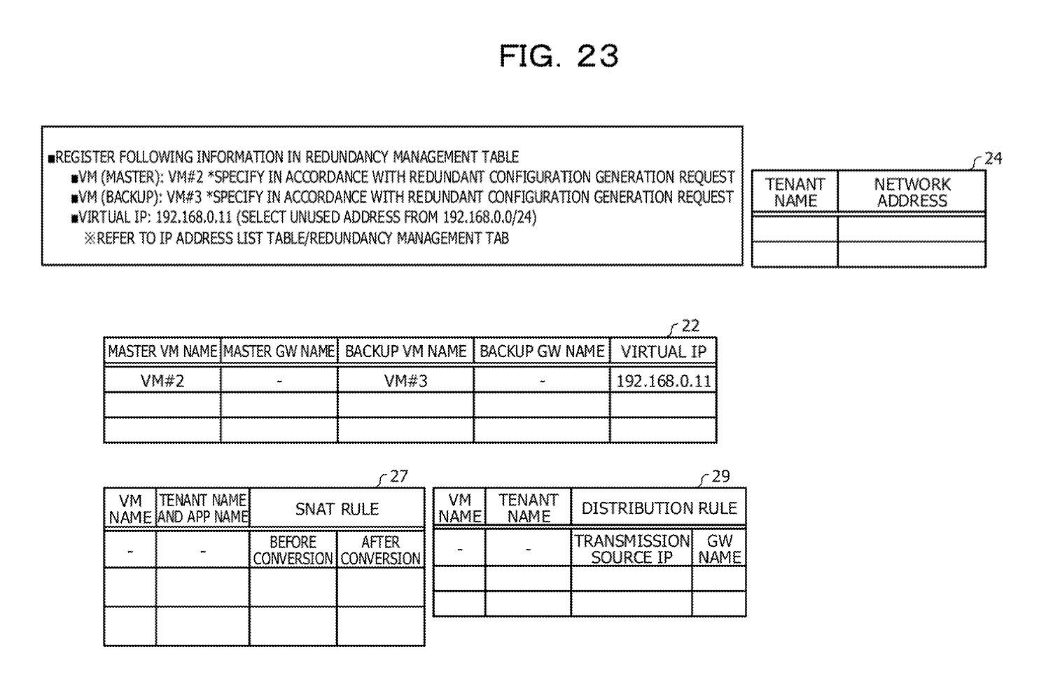

FIG. 22 is a diagram illustrating an example of VRRP setting for GW VMs 3 and FIG. 23 is a diagram illustrating a table configuration (after VRRP setting for the VMs 3) in the GW configuration management device 2. As illustrated in FIG. 22, the GW configuration management device 2 is notified of a redundant configuration generation request, for example, from the operator. Then, the GW configuration management device 2 updates the redundancy management table 22 and performs VRRP setting on VM#2 and VM#3.

As illustrated in FIG. 23, in the redundancy management table 22, VM#2 is registered as a master VM 3, VM#3 is registered as a backup VM 3, and 192.168.0.11 is registered as a virtual IP address.

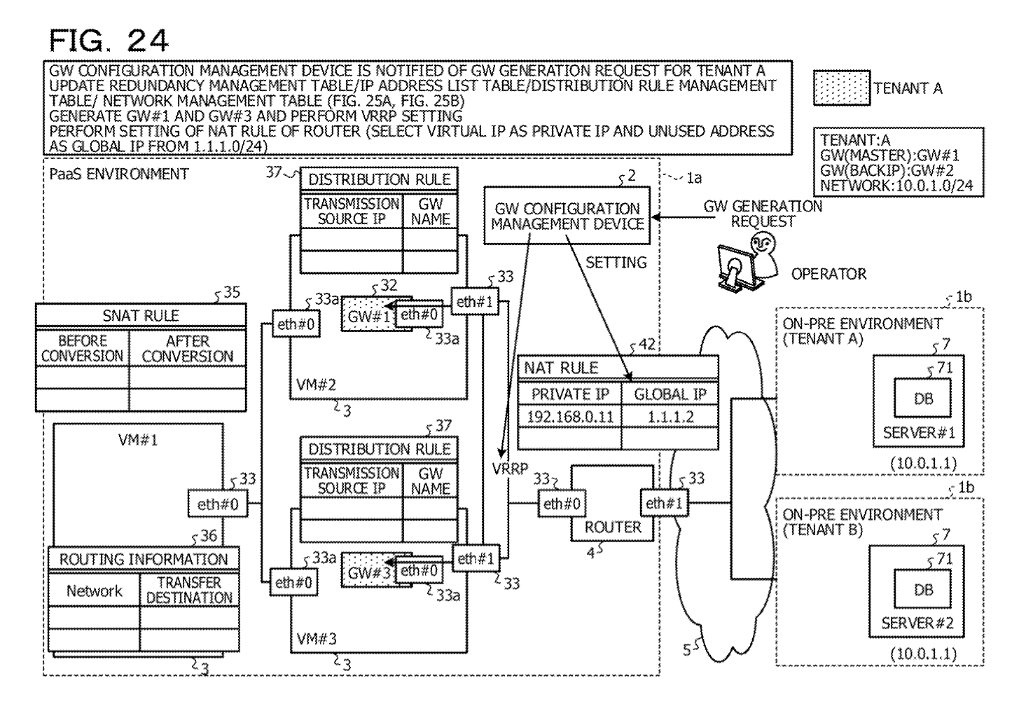

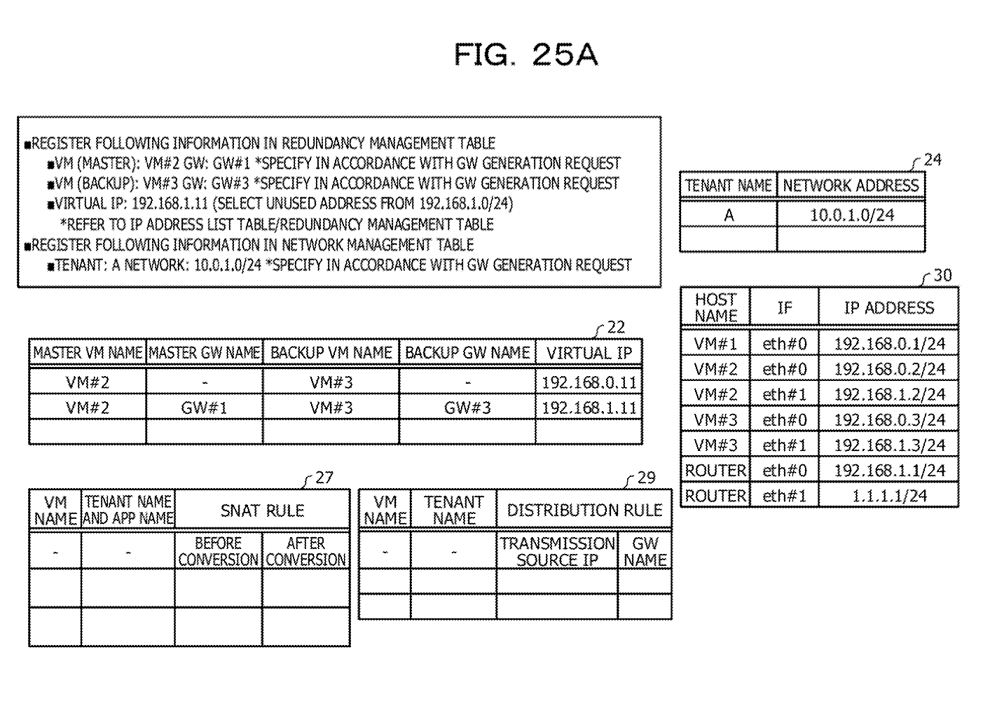

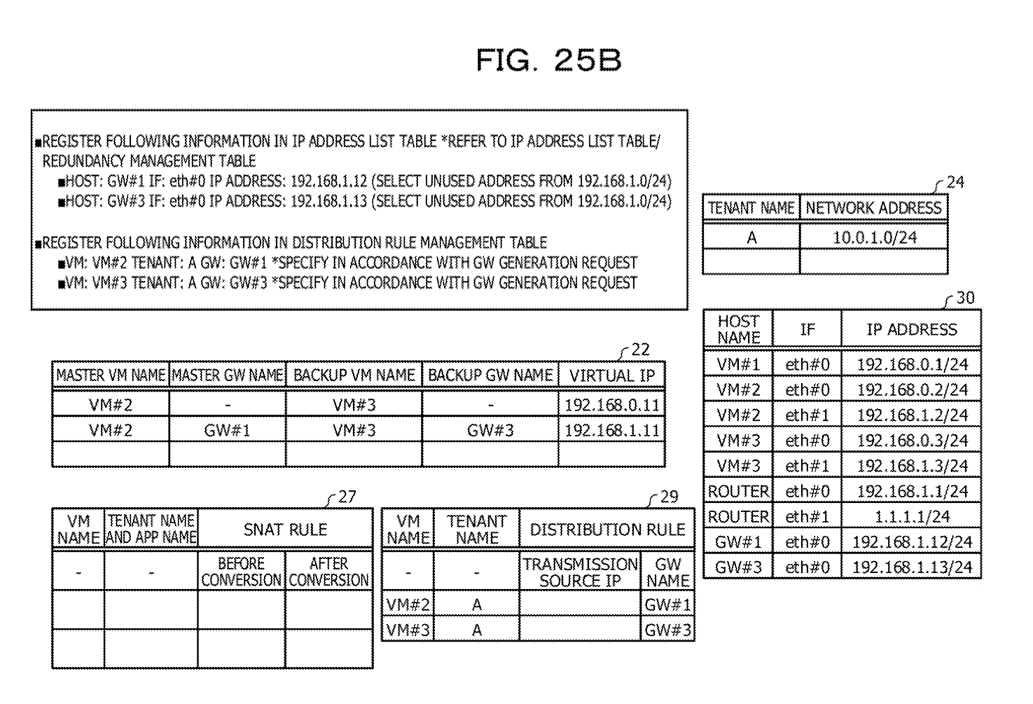

FIG. 24 is a diagram illustrating an example of GW generation and FIG. 25A and FIG. 25B are diagrams each illustrating a table configuration (after generation of the GW 32) in the GW configuration management device 2. As illustrated in FIG. 24, when the GW configuration management device 2 is notified of a GW generation request for the tenant A, for example, from the operator, the GW configuration management device 2 updates the redundancy management table 22, the IP address list table 30, the distribution rule management table 29, and the network management table 24.

The GW configuration management device 2 generates GW#1 and GW#3 and performs VRRP setting. The GW configuration management device 2 also performs setting of a NAT rule of the router 4. In FIG. 24, a NTA rule in which 192.168.0.11, which is a private IP, is converted to 1.1.1.2, which is a global IP, is set for the router 4.

As illustrated in FIG. 25A, in the redundancy management table 22, VM#2 and GW#1 are registered as the master VM 3 and the master GW 32 and VM#3 and GW#3 are registered as the backup VM 3 and the backup GW 32. Also, 192.168.1.11 is registered as a virtual IP address therein. Also, in the network management table 24, 10.0.1.0/24 is registered as the IP address and the subnet mask of the on-pre environments 1b of the tenant A.

As illustrated in FIG. 25B, in the IP address list table 30, GW#1 is registered as a host, eth#0 is registered as an interface, and 192.168.1.12/24 is registered as the IP address and the subnet mask. Also, in the IP address list table 30, GW#3 is registered as a host, eth#0 is registered as an interface, and 192.168.1.13/24 is registered as the IP address and the subnet mask. In the distribution rule management table 29, it is registered that a distribution destination of the tenant A is GW#1 in VM#2 and a distribution destination of the tenant A is GW#3 in VM#3.

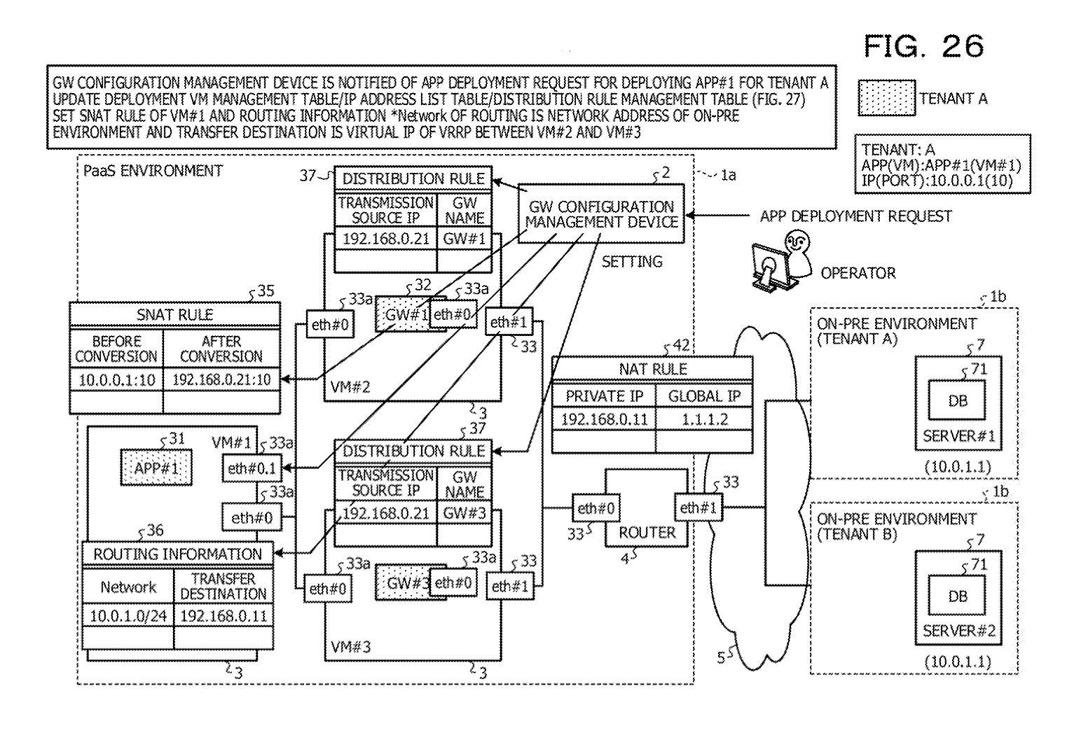

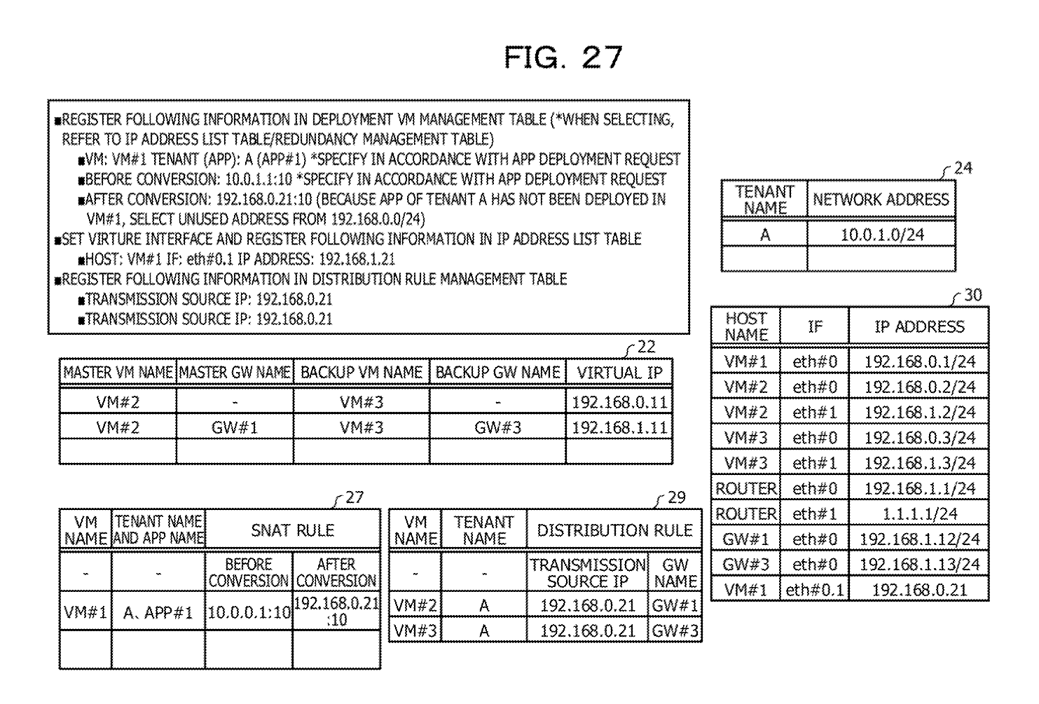

Next, an example of app deployment will be described with reference to FIG. 26 and FIG. 27. FIG. 26 is a diagram illustrating an example of app deployment and FIG. 27 is a diagram illustrating a table configuration (after deployment of the app 31) in the GW configuration management device 2. As illustrated in FIG. 26, when the GW configuration management device 2 is notified of an app deployment request, for example, from the operator, the GW configuration management device 2 updates the deployment VM management table 27, the IP address list table 30, and the distribution rule management table 29.

The GW configuration management device 2 sets an SNAT rule and routing information of VM#1 and sets distribution rules of VM#2 and VM#3. In FIG. 26, an SNAT rule in which the transmission source IP address is converted from 10.0.0.1 to 192.168.0.21 is added to the NAT table 35. Routing information indicating that a packet the IP address of the transmission destination of which is 10.0.1.0/24 is transferred to 192.168.0.11 is added to the routing table 36.

A distribution rule in which a packet the transmission source IP address of which is 192.168.0.21 is distributed to GW#1 is also added to the distribution rule table 37 of VM#2. A distribution rule in which a packet the transmission source IP address of which is 192.168.0.21 is distributed to GW#3 is also added to the distribution rule table 37 of VM#3.

As illustrated in FIG. 27, in the deployment VM management table 27, it is also added with the SNAT rule that APP#1 of the tenant A has been deployed in VM#1. In the IP address list table 30, eth#0.1, which is the virtual interface 33a, is added to VM#1. The virtual IP address set for eth#0.1 is 192.168.0.21. In the distribution rule management table 29, for the tenant A, a distribution rule that has been added to the distribution rule tables 37 of VM#2 and VM#3 is added.

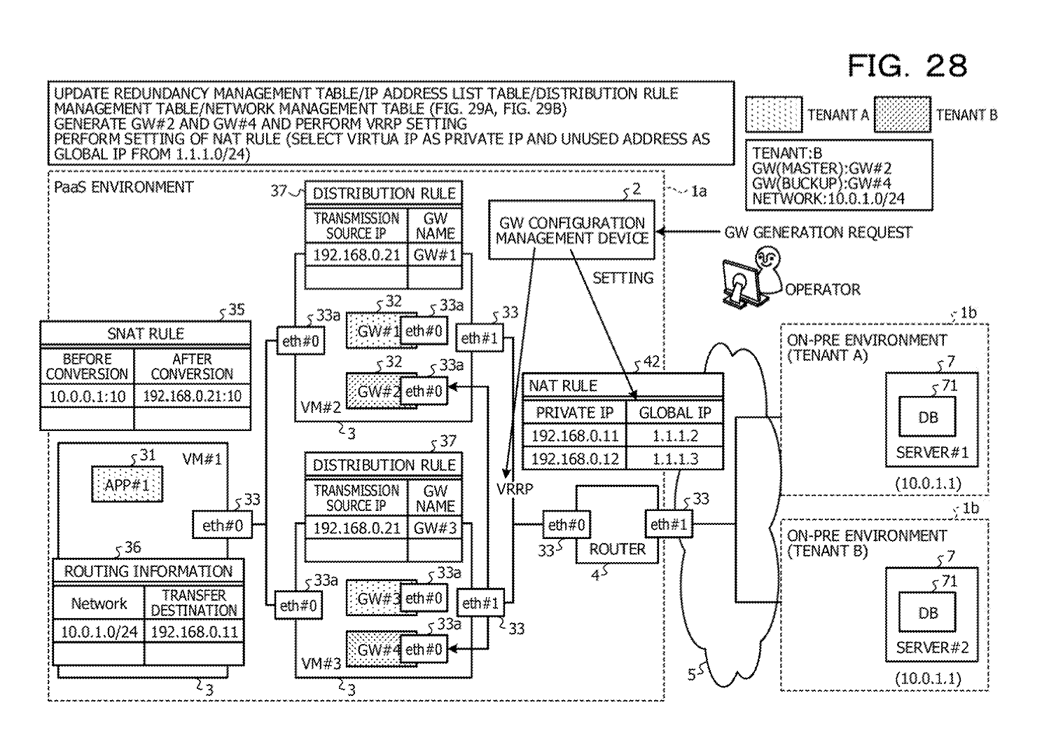

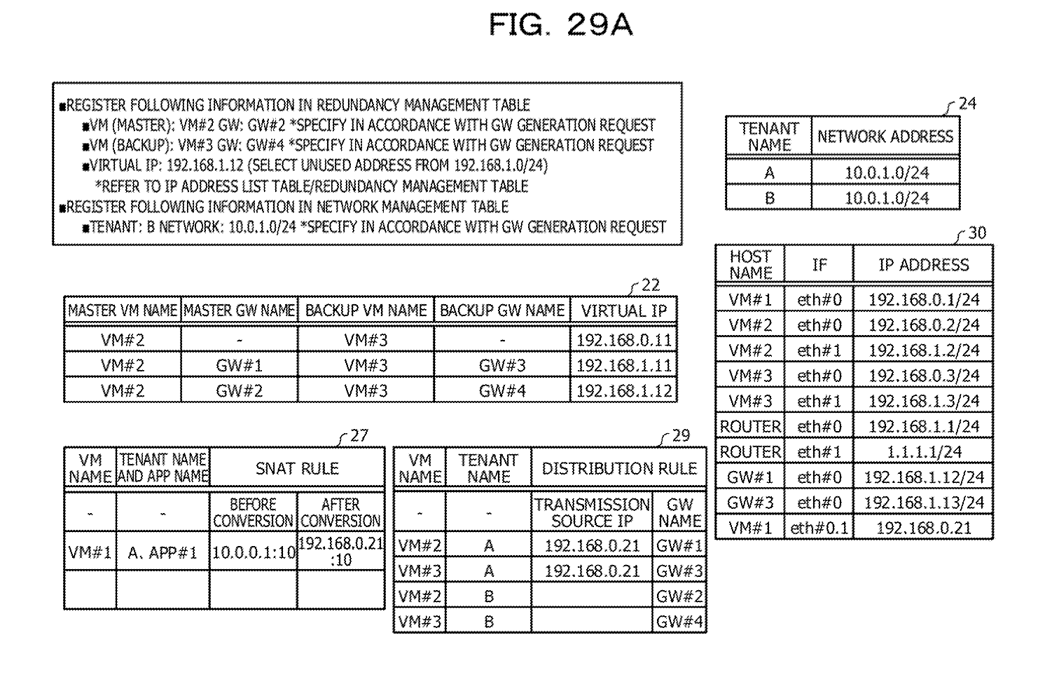

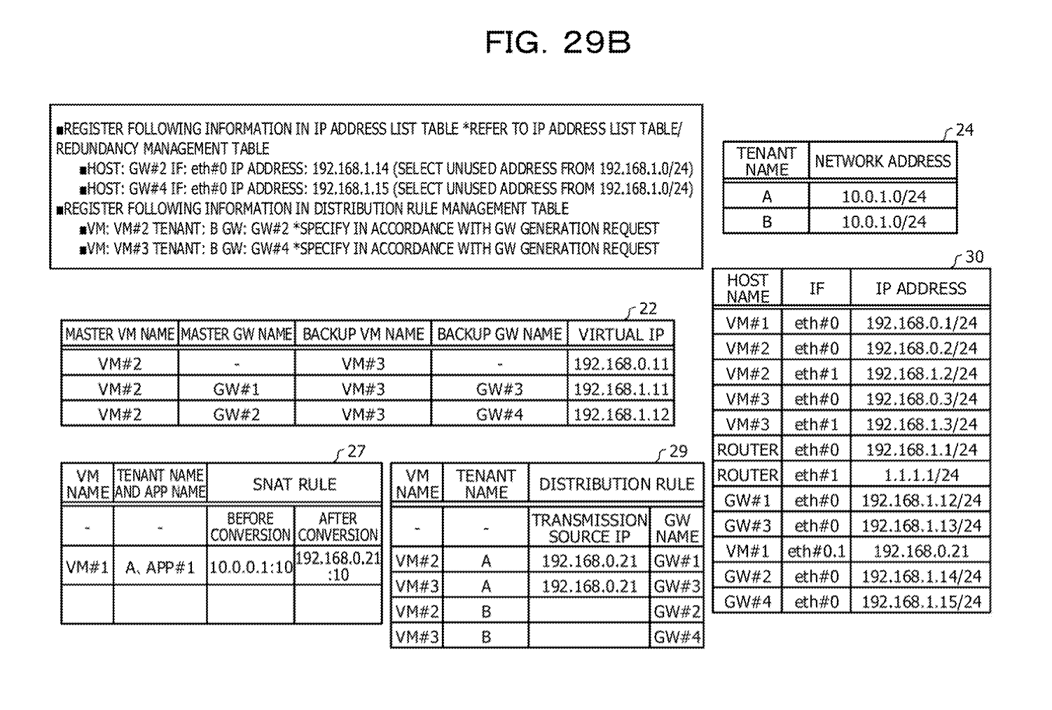

Next, an example of addition of the GW 32 and the app 31 of another tenant will be described with reference to FIG. 28 to FIG. 31. FIG. 28 is a diagram illustrating an example of addition of the GW 32 and FIG. 29A and FIG. 29B are diagrams each illustrating a table configuration (after addition of the GW 32) in the GW configuration management device 2. As illustrated in FIG. 28, when the GW configuration management device 2 is notified of a GW generation request for the tenant B from, for example, the operator, the GW configuration management device 2 updates the redundancy management table 22, the IP address list table 30, the distribution rule management table 29, and the network management table 24.

The GW configuration management device 2 generates GW#2 and GW#4 and performs VRRP setting. The GW configuration management device 2 also performs setting of a NAT rule of the router 4. In FIG. 28, a NAT rule in which 192.168.0.12 of a private IP is converted to 1.1.1.3 of a global IP is set for the router 4.

As illustrated in FIG. 29A, in the redundancy management table 22, VM#2 and GW#2 are registered as the master VM 3 and the master GW 32 and VM#3 and GW#4 are registered as the backup VM 3 and the backup GW 32. Also, 192.168.1.12 is registered as a virtual IP address therein. In the network management table 24, 10.0.1.0/24 is registered as the IP address and the subnet mask of the on-pre environments 1b of the tenant B.

As illustrated in FIG. 29B, in the IP address list table 30, GW#2 is registered as a host, eth#0 is registered as an interface, and 192.168.1.14/24 is registered as the IP address and the subnet mask. Also, in the IP address list table 30, GW#4 is registered as a host, eth#0 is registered as an interface, and 192.168.1.15/24 is registered as the IP address and the subnet mask. In the distribution rule management table 29, it is registered that a distribution destination of the tenant B is GW#2 in VM#2 and a distribution destination of the tenant B is GW#4 in VM#3.

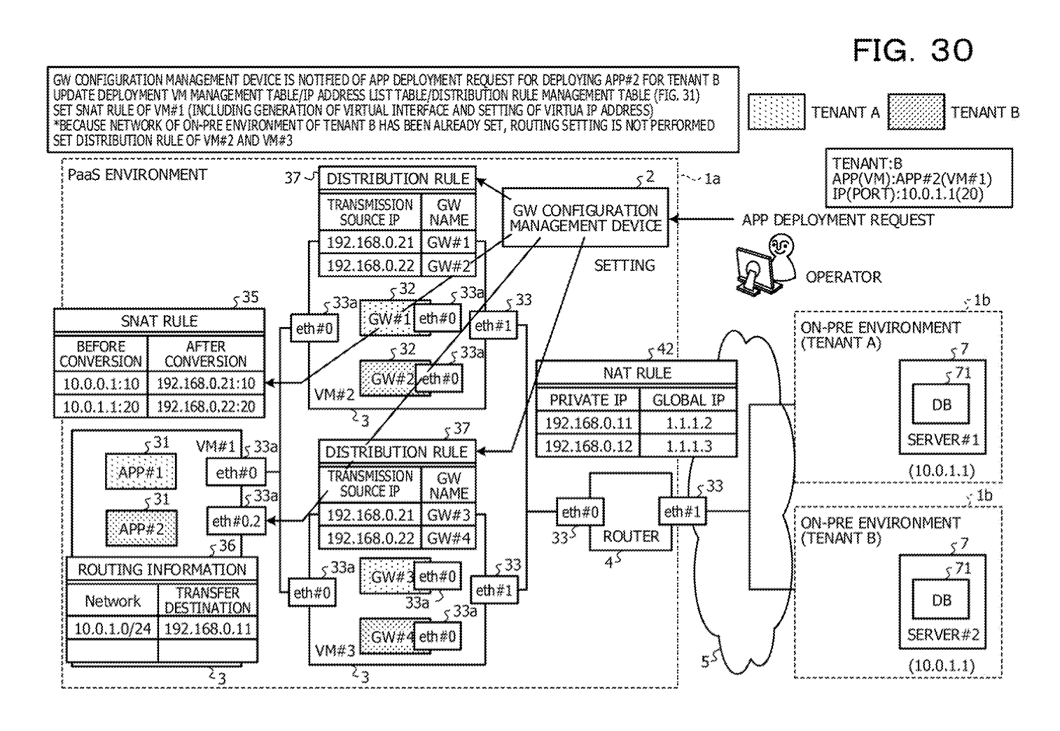

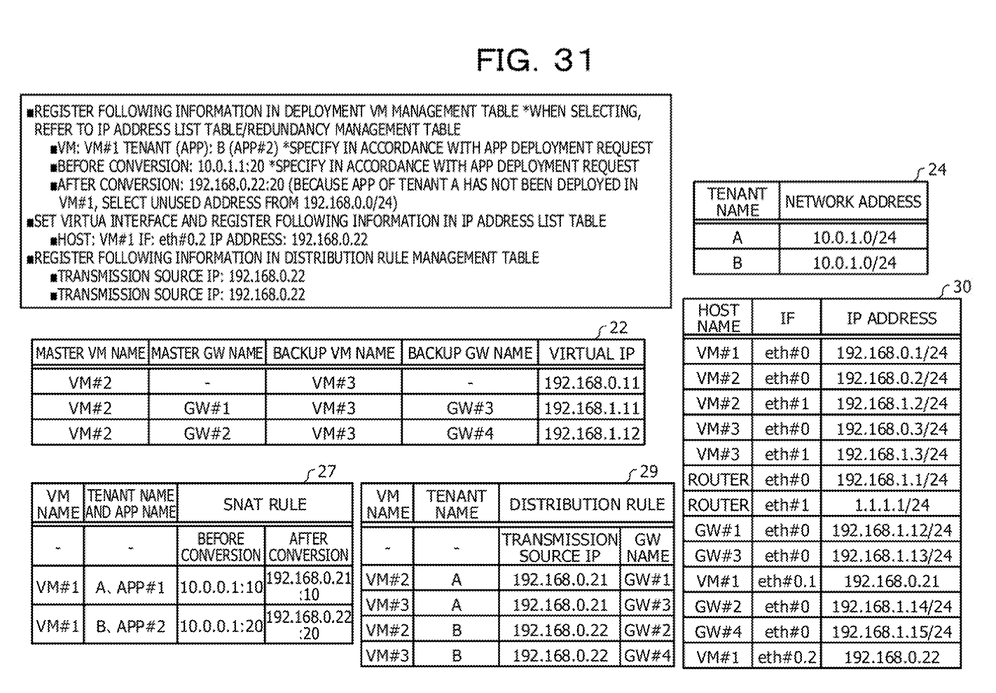

FIG. 30 is a diagram illustrating an example of addition of an app and FIG. 31 is a diagram illustrating a table configuration (after addition of the app 31) in the GW configuration management device 2. As illustrated in FIG. 30, when the GW configuration management device 2 is notified of a deployment request for deploying APP#2 for the tenant B, for example, from the operator, the GW configuration management device 2 updates the deployment VM management table 27, the IP address list table 30, and the distribution rule management table 29.

The GW configuration management device 2 performs setting of an SNAT rule of VM#1 as well as generation of the virtual interface 33a and setting of a virtual IP address and sets distribution rules of VM#2 and VM#3. In FIG. 30, an SNAT rule in which the transmission source IP address is converted from 10.0.1.1 to 192.168.0.22 is added to the NAT table 35.

A distribution rule in which a packet the transmission source IP address of which is 192.168.0.22 is distributed to GW#2 is added to the distribution rule table 37 of the VM#2. A distribution rule in which a packet the transmission source IP address of which is 192.168.0.22 is distributed to GW#4 is added to the distribution rule table 37 of the VM#3.

As illustrated in FIG. 31, in the deployment VM management table 27, it is added with the SNAT rule that APP#2 of the tenant B has been deployed in VM#1. In the IP address list table 30, eth#0.2, which is the virtual interface 33a, is added to VM#1. The virtual IP address that is set for eth#0.2 is 192.168.0.22. In the distribution rule management table 29, for the tenant B, the distribution rule that has been added to the distribution rule tables 37 of VM#2 and VM#3 is added.

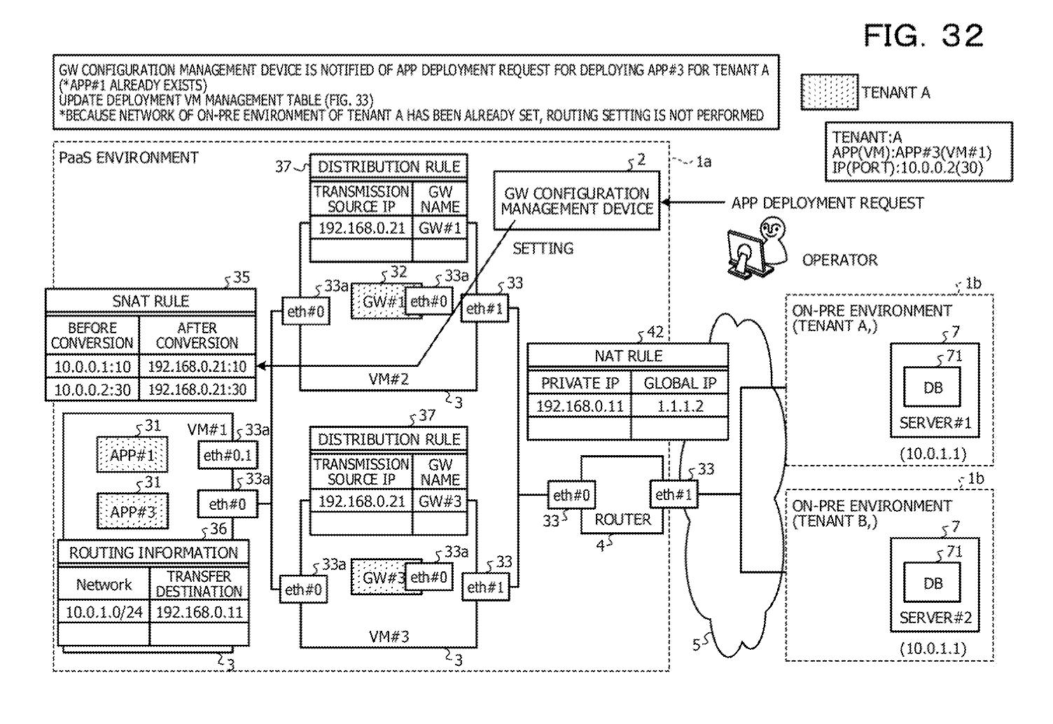

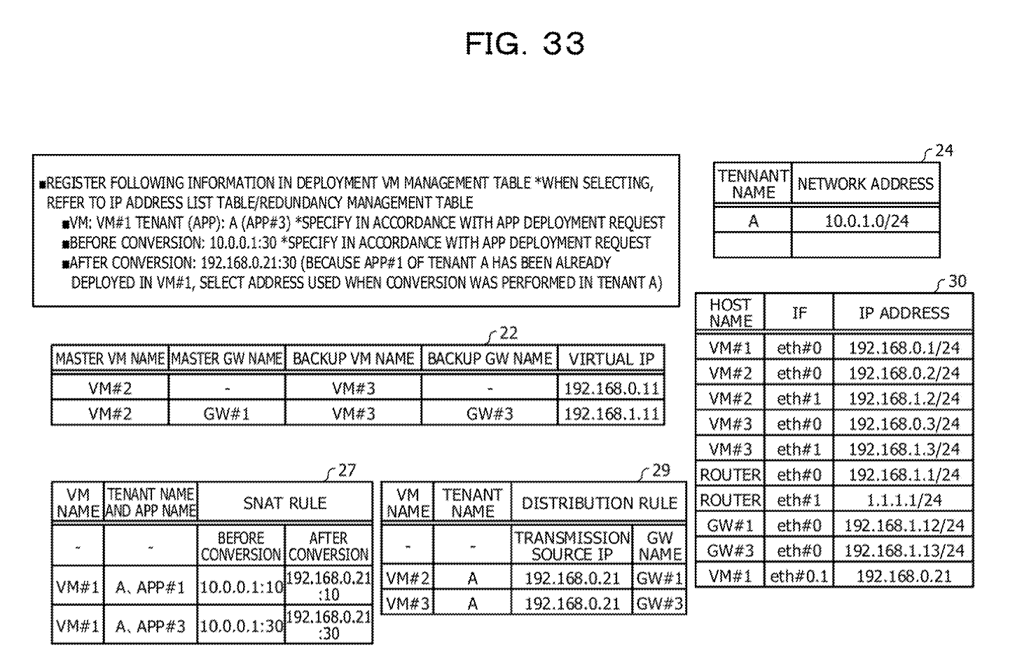

Next, an example of deployment of a plurality of apps 31 of the same tenant will be described with reference to FIG. 32 and FIG. 33. FIG. 32 is a diagram illustrating an example of deployment of a plurality of apps 31 of the same tenant and FIG. 33 is a diagram illustrating a table configuration (after deployment of the apps 31) in the GW configuration management device 2. As illustrated in FIG. 32, when the GW configuration management device 2 is notified of an app deployment request for deploying APP#3 for the tenant A, for example, from the operator, the GW configuration management device 2 updates the deployment VM management table 27. Note that, because the network of the on-pre environments 1b of the tenant A has been already set, routing setting is not performed.

As illustrated in FIG. 33, in the deployment VM management table 27, it is added with the SNAT rule that APP#3 of the tenant A has been deployed in VM#1. Note that, for the transmission source IP address after conversion of the SNAT rule, because APP#1 of the tenant A has been deployed in VM#1, 192.168.0.21, which was used when conversion was performed in the tenant A, is selected.

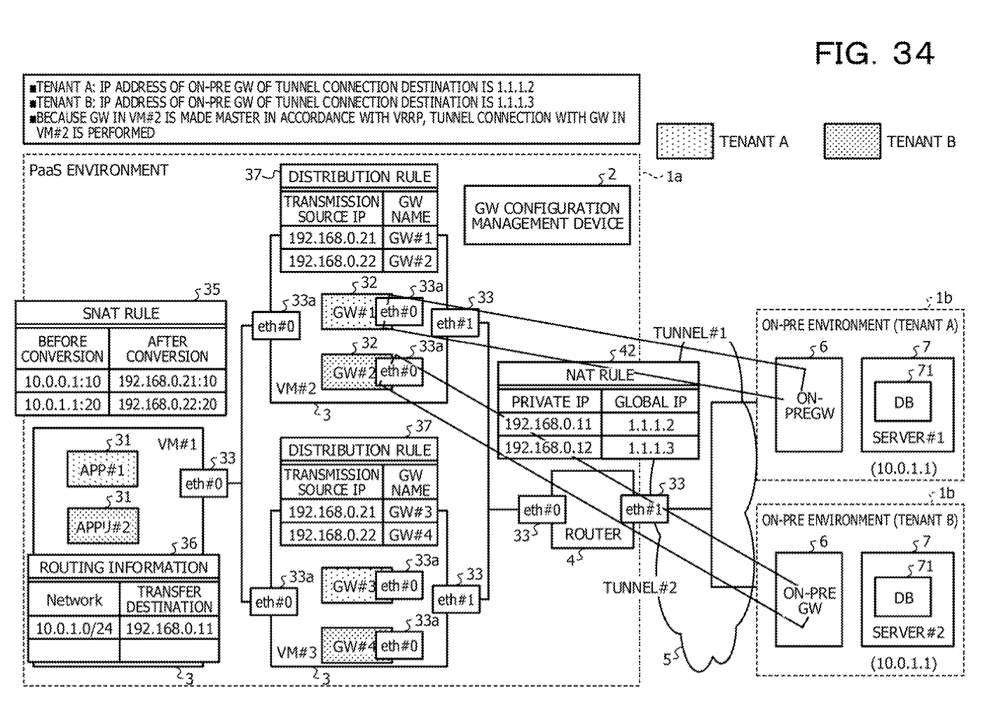

Next, an example of tunnel setting will be described. FIG. 34 is a diagram illustrating an example of tunnel setting. As illustrated in FIG. 34, in the tenant A, the IP address of the on-pre GW 6 of a tunnel connection destination is 1.1.1.2 and, in the tenant B, the IP address of the on-pre GW 6 of a tunnel connection destination is 1.1.1.3. Because the GW 32 in VM#2 is made to be a master in accordance with the VRRP, a tunnel connection with the GW 32 in VM#2 is performed.

As has been described above, in the embodiment, for each tenant, the NAT rule setting unit 26 generates the virtual interface 33a in the app VM 3 and sets a virtual IP address. Then, the NAT rule setting unit 26 generates an SNAT rule in which the transmission source IP address of a packet that is transmitted from the app 31 is converted to a virtual IP address and sets the SNAT rule in the NAT table 35 of the app VM 3. The GW generation unit 21 generates a GW 32 that is tunnel-connected with the on-pre GW 6 in the GW VM 3. The GW routing setting unit 25 generates routing information indicating that a transfer destination of a packet that is transmitted from the app 31 is the GW VM 3 and sets the routing information in the routing table 36 of the app VM 3. Then, the distribution rule setting unit 28 generates a distribution rule in which a packet that has been transmitted from the app VM 3 is distributed to the GW 32, based on the transmission source IP address, and sets the distribution rule in the distribution rule table 37 of the GW VM 3.

Therefore, with the GW configuration management device 2, a configuration in which the description of the app 31 is not changed may be achieved. Also, with the GW configuration management device 2, it is enabled to generate GWs 32 of a plurality of tenants in the GW VM 3, and the number of VMs 3 is not increased. Therefore, with the GW configuration management device 2, the number of global IP addresses that are consumed is not increased.

In the embodiment, the GW generation unit 21 makes the GW 32 redundant in accordance with the VRRP and sets a virtual IP address for a master GW 32 and a backup GW 32. Then, the GW generation unit 21 generates a NAT rule in which the virtual IP address set for the master GW 32 and the backup GW 32 is converted to a global IP address. Then, the router setting unit 23 sets the NAT rule in the NAT table 42 of the router 4. Also, the GW generation unit 21 makes the GW VM 3 redundant, sets a virtual IP address, and causes the set virtual IP address to be a transfer destination of routing information of the app VM 3. Therefore, the GW configuration management device 2 is capable of making tunnel connection between the PaaS environment 1a and the on-pre environments 1b redundant and increasing reliability.

Note that, although, in the embodiment, the GW configuration management device 2 that operates as a communication control device has been described, a GW configuration management program that has a similar function may be achieved by realizing a configuration of the GW configuration management device 2 by software. Therefore, a computer that executes the GW configuration management program will be described.

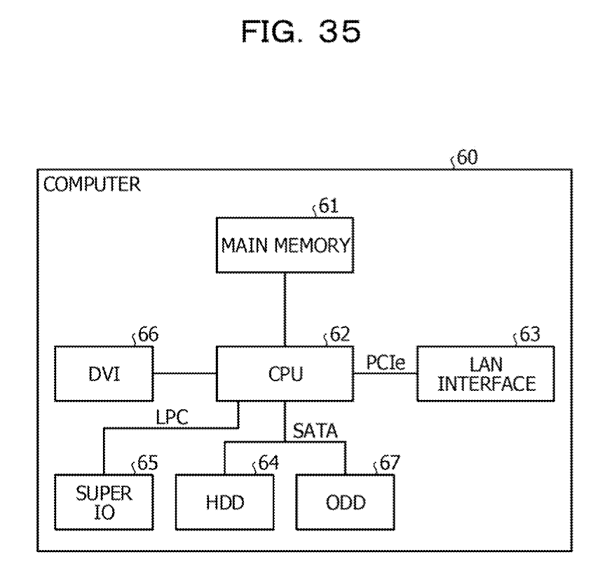

FIG. 35 is a diagram illustrating a hardware configuration of a computer that executes a GW configuration management program according to another embodiment. As illustrated in FIG. 35, a computer 60 includes a main memory 61, a CPU 62, a local area network (LAN) interface 63, and a hard disk drive (HDD) 64. The computer 60 also includes a super input output (10) 65, a digital visual interface (DVI) 66, and an optical disk drive (ODD) 67.

The main memory 61 is a memory that stores a program, an execution interim result of the program, or the like. The CPU 62 is a central processing device that reads out a program from the main memory 61 and executes the program. The CPU 62 includes a chip set that includes a memory controller.

The LAN interface 63 is an interface used for connecting the computer 60 to another computer via a LAN. The HDD 64 is a disk device that stores a program and data and the super IO 65 is an interface used for connecting an input device, such as a mouse, a key board, or the like. The DVI 66 is an interface used for connecting a liquid crystal display device and the ODD 67 is a device that reads and writes data from and to a DVD.

The LAN interface 63 is connected to the CPU 62 via a PCI express (PCIe) bus and the HDD 64 and the ODD 67 are connected to the CPU 62 via a serial advanced technology attachment (SATA) bus. The super IO 65 is connected to the CPU 62 via a low pin count (LPC) bus.

The GW configuration management program that is executed in the computer 60 is stored in a DVD, is read out from the DVD by the ODD 67, and is installed on the computer 60. As another option, the GW configuration management program is stored in a database of another computer system or the like connected thereto via the LAN interface 63, is read out from the database or the like, and is installed on the computer 60. Then, the installed GW configuration management program is stored in the HDD 64, is read out onto the main memory 61, and is executed by the CPU 62.

Also, although, in the above-described embodiment, a case where the GW configuration management device 2 is different from the PaaS management device 8 has been described, the present disclosure is not limited thereto and may be similarly applied to a case where the GW configuration management device 2 and the PaaS management device 8 are the same.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a communication control program that causes a computer to execute a process, the process comprising:
generating, for each of a plurality of tenants, a plurality of virtual interfaces on a first virtual machine, the first virtual machine executing an application for the plurality of tenants;
allocating each of a plurality of virtual IP addresses to each of the plurality of virtual interfaces;
applying, to the first virtual machine, a first conversion rule in which an IP address of a transmission source of a packet output from the application is converted to one of the plurality of virtual IP addresses allocated for a virtual interface corresponding to one of the plurality of tenants, the packet relating to the one of the plurality of tenants;
generating, for each of a plurality of tenants, a plurality of gateways on a second virtual machine, each of the plurality of gateways being configured to transmit the packet to a transmission destination by tunneling;
applying, to the first virtual machine, routing information so as transmit the packet addressed to the transmission destination to the second virtual machine; and
applying, to the second virtual machine, a distribution rule in which a packet, transmitted to the second virtual machine based on the routing information, is distributed to one of the plurality of gateways, based on the IP address of the transmission source of the packet.

2. The non-transitory computer-readable storage medium according to claim 1, wherein the process further comprises:
generating a redundant second virtual machine in accordance with a redundancy protocol;
allocating a virtual IP address for the redundant second virtual machine;
generating redundant gateways for each of the plurality of tenants in accordance with the redundancy protocol, one of the redundant gateways being generated on the second virtual machine, other of the redundant gateways being generated on the redundant second virtual machine;
allocating each of a plurality of virtual IP addresses to the redundant gateways; and
applying, to a router, a second conversion rule in which the virtual IP address is converted to a global IP address, the router being configured to transmit the packet to which information for tunneling has been added in any one of the plurality of gateways to an external network; wherein
transfer destination indicated by the routing information is a virtual IP address of the second virtual machine or the redundant second virtual machine.

3. The non-transitory computer-readable storage medium according to claim 2,
wherein the first virtual machine, the second virtual machine, and the router are included in a PaaS environment and the transmission destination is a gateway included in an on-premises environment.

4. The non-transitory computer-readable storage medium according to claim 2,
wherein the redundancy protocol is a virtual router redundancy protocol.

5. A communication control method executed by a computer, the communication control method comprising:
generating, for each of a plurality of tenants, a plurality of virtual interfaces on a first virtual machine, the first virtual machine executing an application for the plurality of tenants;
allocating each of a plurality of virtual IP addresses to each of the plurality of virtual interfaces;
applying, to the first virtual machine, a first conversion rule in which an IP address of a transmission source of a packet output from the application is converted to one of the plurality of virtual IP addresses allocated for a virtual interface corresponding to one of the plurality of tenants, the packet relating to the one of the plurality of tenants;
generating, for each of a plurality of tenants, a plurality of gateways on a second virtual machine, each of the plurality of gateways being configured to transmit the packet to a transmission destination by tunneling;
applying, to the first virtual machine, routing information so as transmit the packet addressed to the transmission destination to the second virtual machine; and
applying, to the second virtual machine, a distribution rule in which a packet, transmitted to the second virtual machine based on the routing information, is distributed to one of the plurality of gateways, based on the IP address of the transmission source of the packet.

6. A communication control device comprising:
a memory; and
a processor coupled to the memory and the processor configured to:
generate, for each of a plurality of tenants, a plurality of virtual interfaces on a first virtual machine, the first virtual machine executing an application for the plurality of tenants;
allocate each of a plurality of virtual IP addresses to each of the plurality of virtual interfaces;
apply, to the first virtual machine, a first conversion rule in which an IP address of a transmission source of a packet output from the application is converted to one of the plurality of virtual IP addresses allocated for a virtual interface corresponding to one of the plurality of tenants, the packet relating to the one of the plurality of tenants;
generate, for each of a plurality of tenants, a plurality of gateways on a second virtual machine, each of the plurality of gateways being configured to transmit the packet to a transmission destination by tunneling;
apply, to the first virtual machine, routing information so as transmit the packet addressed to the transmission destination to the second virtual machine; and
apply, to the second virtual machine, a distribution rule in which a packet, transmitted to the second virtual machine based on the routing information, is distributed to one of the plurality of gateways, based on the IP address of the transmission source of the packet.
